(19) United States
(12) Patent Application Publication
(10) Pub. No.: US 2010/0217787 A1
(43) Pub. Date: Aug. 26, 2010

(54) CONTROLLER, INFORMATION RECORDING DEVICE, ACCESS DEVICE, INFORMATION RECORDING SYSTEM, AND INFORMATION RECORDING METHOD

(76) Inventors: Makoto Ochi, Osaka (JP); Takuji Maeda, Osaka (JP); Hiroki Etoh, Osaka (JP); Masahiro Nakamura, Hyogo (JP); Shinji Inoue, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/738,834

(22) PCT Filed: Jul. 1, 2009
(86) PCT No.: PCT/JP2009/003060

§ 371 Date: Apr. 19, 2010

(30) Foreign Application Priority Data
Jul. 2, 2008 (JP) 2008-172978
Jul. 2, 2008 (JP) 2008-172981

(51) Int. Cl. G06F 17/30; G06F 12/00

(52) U.S. Cl. 707/823; 711/154; 707/E17.01; 711/E12.001

(57) ABSTRACT

In a file system such as an FAT file system, clusters are linked only in the forward direction. To perform seeks to clusters in the reverse direction, links need to be followed from the beginning side of the file data in every seeking operation. When a large amount of data is subjected to such reverse seeking, the overhead will be particularly large. A memory controller (101) for controlling data writing or reading to or from an information recording medium includes a control unit (105) that detects continuity of data in an address space of a file system managing data that is recorded into the information recording medium and a data-continuity management unit (103) that stores information about the continuity of the data as data-continuity information.

### TECHNICAL FIELD

The present invention relates to a controller, an information recording device, an access device, an information recording system, and an information recording method for recording data.

### BACKGROUND ART

A variety of media are used to store digital data (hereafter referred to as “content”) such as music content, moving image content, and still image content. Examples include magnetic disks, optical discs, magneto-optical disks, and semiconductor memory cards. The size of data recorded onto such recording media tends to increase as, for example, digital cameras achieve a higher resolution or as movie cameras record image data with a higher quality requiring a higher bit rate. As electronic devices become more sophisticated and storage media tend toward a larger capacity, there can be cases where an ever-larger amount of data is written as a single file in a recording medium at a high speed.

Data stored in a recording medium is commonly managed using a file system. A file allocation table (FAT) file system is one conventional file system for managing data. Under the FAT file system, storage areas are managed in units of clusters. To write data, the FAT file system seeks an unoccupied cluster and stores the data into the detected cluster. To read recorded data, the FAT file system seeks a cluster storing the data in the same manner, and then reads the data from the detected cluster.

As the size of data that is written (data managed using the file system) to such storage media increases or as storage media tend toward a larger capacity, the time taken to write or read data increases.

To shorten the time taken to write or read data, one technique determines an optimum access method under the file system for each semiconductor memory card depending on the characteristics of each semiconductor memory card so that predetermined access performance will be achieved with the optimum method in the file system of the semiconductor memory card and the corresponding host device.

For example, with a technique described in Patent Citation 1, a semiconductor memory card stores information about its access performance, and a host device obtains at least a part of the information about the access performance of the semiconductor memory card. The host device then adjusts processing performed under the file system based on the obtained information. This technique enables continuous data to be written to the semiconductor memory card at a high speed.

Patent Citation 1: International Publication No. 2005/015406

### DISCLOSURE OF INVENTION

### Technical Problem

In the FAT file system for example, information about links between clusters indicates links to clusters only in the forward direction. To seek (or to read data) in the reverse direction, which requires data to be read in the direction from the end toward the beginning of file data (when, for example, reverse play from the end is performed), links need to be followed from the beginning side of the file data in every seeking operation. When a large amount of data is subjected to such reverse seeking, the overhead will be particularly large (or the processing time required for seeking will be long).

To solve the above problems, it is an object of the present invention to provide a controller, an information recording device, an access device, an information recording system, and an information recording method that enable seeking of data that is managed under an FAT file system to be performed at a higher speed.

### Technical Solution

A first aspect of the present invention provides a controller for controlling data writing or data reading to or from an information recording medium. The controller includes a control unit and a data-continuity management unit.

The control unit detects a continuity of data in an address space of a file system. The file system manages data that is recorded into the information recording medium. The data-continuity management unit stores information about the continuity of data as data-continuity information.

This structure enables the controller to have information about the continuity of data, and enables seeking of data that is managed under the file system to be performed at a higher speed.

A second aspect of the present invention provides the controller of the first aspect of the present invention in which the control unit outputs information based on the data-continuity information that is stored in the data-continuity management unit to an external unit.

This structure enables an external device connected to the controller to obtain information about continuity of data.

A third aspect of the present invention provides the controller of the first or second aspect of the present invention in which the control unit changes the data-continuity information stored in the data-continuity management unit in accordance with a request transmitted from an external unit.

This structure enables an external unit to correct or update data-continuity information.

A fourth aspect of the present invention provides the controller of one of the first to third aspects of the present invention further including a file system information management unit that recognizes information managed by the file system.

This structure enables the controller to recognize continuity of a file that is recorded into an information medium, and enables seeking of data that is managed under the file system to be performed at a higher speed.

A fifth aspect of the present invention provides the controller of one of the first to fourth aspects of the present invention in which the file system information management unit changes the data-continuity information based on the data-continuity information and the information managed by the file system.

This structure enables data-continuity information to be updated accordingly when, for example, data is changed.

A sixth aspect of the present invention provides the controller of one of the first to fourth aspects of the present invention in which the file system information management unit changes the data-continuity information based on the data-continuity information and the information managed by the file system when a request to change the data-continuity information is transmitted from an external unit.

This structure enables data-continuity information to be updated in accordance with a request transmitted from an external unit.

A seventh aspect of the present invention provides the controller of one of the first to sixth aspects of the present invention in which the information recording medium to be controlled is a nonvolatile memory.

This structure enables the information recording medium to be nonvolatile, and enables recorded data to remain unchanged even when the power supply is stopped.

An eighth aspect of the present invention provides an information recording device including an information recording medium and a controller for controlling data writing or data reading to or from the information recording medium. The controller includes a control unit and a data-continuity management unit.

The control unit detects a continuity of data in an address space of a file system managing data recorded into the information recording medium. The data-continuity management unit stores information about the continuity of data as data-continuity information.

This structure enables the controller to have information about the continuity of data, and enables seeking of data that is managed under the file system to be performed at a higher speed.

The information recording device may be an information recording module.

A ninth aspect of the present invention provides the information recording device of the eighth aspect of the present invention in which the memory controller further includes a card information management unit that stores an access condition under which data is recorded continuously into the information recording medium. The control unit outputs the access condition to an external unit.

This structure enables an external device connected to the information recording device to obtain information about continuity of data.

A tenth aspect of the present invention provides the information recording device of the eighth or ninth aspect of the present invention in which the control unit outputs information based on data-continuity information that is stored in the data-continuity management unit to an external unit.

This structure enables an external device connected to the information recording device to obtain information about continuity of data.

An eleventh aspect of the present invention provides the information recording device of the eighth or tenth aspect of the present invention in which the control unit changes data-continuity information stored in the data-continuity management unit in accordance with a request transmitted from an external unit.

This structure enables an external unit to correct or update data-continuity information.

A twelfth aspect of the present invention provides an information recording device including an information recording medium and a controller for controlling data writing or data reading to or from the information recording medium. The controller includes a control unit, a file system information management unit and a data-continuity management unit.

The control unit detects a continuity of data in an address space of a file system managing data that is recorded into the information recording medium. The data-continuity management unit stores information about the continuity of data as data-continuity information. The file system information management unit recognizes information managed by the file system.

This structure enables the controller to recognize continuity of a file that is recorded into an information medium, and enables seeking of data that is managed under the file system to be performed at a higher speed.

A thirteenth aspect of the present invention provides the information recording device of the twelfth aspect of the present invention in which the file system information management unit changes the data-continuity information based on the data-continuity information and the information managed by the file system.

This structure enables data-continuity information to be updated accordingly when, for example, data is changed.

A fourteenth aspect of the present invention provides the information recording device of the twelfth aspect of the present invention in which the file system information management unit changes the data-continuity information based on the data-continuity information and the information managed by the file system when a request to change the data-continuity information is transmitted from an external unit.

This structure enables data-continuity information to be updated in accordance with a request transmitted from an external unit.

A fifteenth aspect of the present invention provides the information recording device of one of the fifth to fourteenth aspects of the present invention in which the information recording medium is a nonvolatile memory.

This structure enables the information recording medium to be nonvolatile, and enables recorded data to remain unchanged even when the power supply is stopped.

A sixteenth aspect of the present invention provides an access device that connects an information recording medium and an information recording device. The information recording device includes a controller for controlling the information recording medium. The access device includes a control unit and a file system control unit.

The control unit receives from the information recording device an access condition under which data is recorded continuously into the information recording medium. The file system control unit determines an address of data that is recorded into the information medium based on the access condition.

This structure enables the access device to write data to the information recording device in an optimum manner.

The access device may be an access module.

A seventeenth aspect of the present invention provides an access device that connects an information recording medium and an information recording device. The information recording device includes a controller for controlling the information recording medium. The access device includes a control unit and a file system control unit.

The control unit receives from the information recording device data-continuity information indicating a continuity of data in an address space that has been recorded into the information recording medium. The file system control unit receives data from the information recording device based on the data-continuity information.

This structure enables the access device to read data from the information recording device in an optimum manner.

An eighteenth aspect of the present invention provides an information recording system including the information recording device of the eighth aspect of the present invention and the access device of the sixteenth or seventeenth aspect of the present invention.

A nineteenth aspect of the present invention provides an information recording method for controlling data writing to an information recording medium. The method includes an address management process, a data-continuity detection process, and a data-continuity information storing process.

In the address management process, a recording position at which data is recorded into the information recording medium is managed using an address. In the data-continuity detection process, a continuity of data in the address space is detected. In the data-continuity information storing process, information about the continuity of data is stored as data-continuity information.

A twentieth aspect of the present invention provides the information recording method of the nineteenth aspect of the present invention further including a file system information recognizing process.

In the file system information recognizing process, information managed by the file system is recognized.

The present invention described above may be implemented as a method that is achieved by software or hardware and executed by a CPU or an integrated circuit.

### ADVANTAGEOUS EFFECTS

The present invention enables seeking of data that is managed using a file system to be performed at a higher speed.

### BRIEF DESCRIPTION OF DRAWINGS

FIG. 1 is a block diagram showing one structure of an information recording system.

FIG. 2 shows the relationship between erase blocks and pages of a flash memory.

FIG. 3 shows one structure of an FAT file system.

FIG. 4 is a flowchart showing an example of processing performed by an access module when recording data into an information recording module.

FIGS. 5A and 5B show one structure of access information that is received by the access module.

FIG. 6 is a flowchart showing an example of a data writing process performed by the information recording module.

FIG. 7 is a flowchart showing an example of a data continuity determination process.

FIG. 8 shows an example of data-continuity information.

FIG. 9 is a flowchart showing an example of processing performed by the access module when reading data.

FIG. 10 shows one structure of data managed by the FAT file system.

FIG. 11 is a flowchart showing determination as to whether a command for reading data managed by the FAT file system is to be transmitted.

FIG. 12 is a flowchart showing an example of processing performed by the information recording module when data is read.

FIG. 13 shows transmission and reception of a command and responses between the access module and the information recording module.

FIG. 14 shows an example of data-continuity information.

FIG. 15 shows an example in which data-continuity information is managed using addresses and a storage area unit.

FIG. 16 is a flowchart showing an example of processing performed by the access module when reading data.

FIG. 17 is a flowchart showing determination as to whether a command for reading data of a plurality of blocks is to be transmitted by a file system control unit.

FIG. 18 shows a data-continuity information requesting command and an example of its processing.

FIG. 19 shows a data-continuity information requesting command and an example of its processing.

FIG. 20 shows an example of processing associated with a data-continuity information updating command in an information recording system.

FIG. 21 shows an example of processing associated with a data-continuity information updating command in an information recording system.

FIG. 22 shows an example in which data-continuity information is identified using ID information.

FIG. 23 is a block diagram showing one structure of an information recording system.

FIG. 24 is a flowchart showing an example of a data writing process performed by an access module.

FIGS. 25A, 25B, and 25C show structures of a directory entry, an FAT, and a data area before the data writing process is performed.

FIGS. 26A, 26A, and 26C show structures of a directory entry, an FAT, and a data area after the data writing process is performed.

FIG. 27 is a flowchart showing an example of internal processing performed by the information recording module when data is updated.

FIG. 28 shows transmission and reception of a command for generating data-continuity information in the information recording system.

FIG. 29 shows transmission and reception of a command for generating data-continuity information in the information recording system.

### EXPLANATION OF REFERENCE

1000, 4000 information recording system
100 information recording module
101 memory controller
102 external I/F unit
103 data-continuity management unit
104 card information management unit
105, 111 control unit
106 storage area I/F unit
107 address information management unit
108 storage area unit
110 access module
112 module accessing unit
113 access module side software
114 application program
115 file system control unit
116 access condition determination unit
117 access control unit
120 FS information management unit
301 storage area unit
301-A file system management area
302 management information storage area
303 data area
304 MBR-PT
305 PBS
306 FAT-1
307 FAT-2
308 RDE
1F FAT

### BEST MODE FOR CARRYING OUT THE INVENTION

### First Embodiment

A first embodiment of the present invention will now be described in detail with reference to the drawings.

### 1.1 Structure of Information Recording System

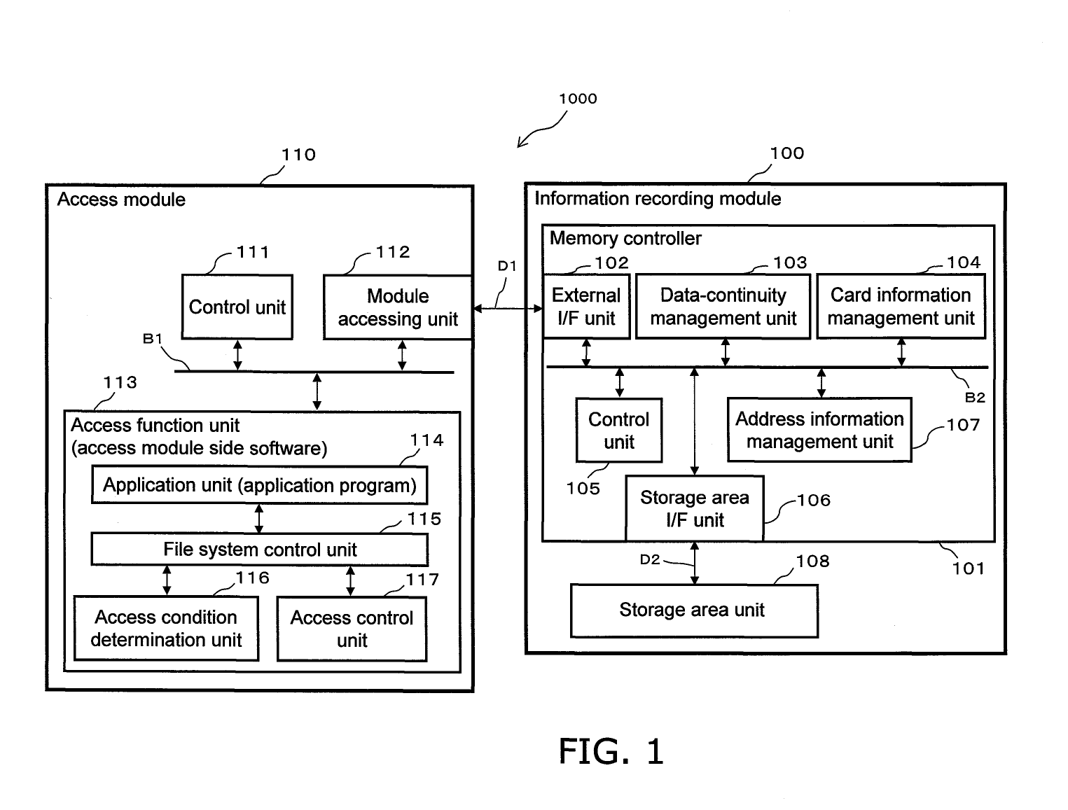

FIG. 1 is a block diagram showing the structure of an information recording system 1000 according to an embodiment of the present invention. As shown in FIG. 1, the information recording system 1000 includes an information recording module (information recording device) 100 and an access module (access device) 110. The information recording module (information recording device) 100 and the access module (access device) 110 are connected to each other with a transmission line D1, via which they can communicate with each other by, for example, transmitting and receiving commands and data.

### 1.1.1 Structure of Information Recording Module

The information recording module 100 includes a memory controller 101 and a storage area unit 108. The information recording module 100 may be, for example, a recording medium such as a semiconductor memory card, or a data recording circuit incorporated in a device such as a player, a recorder, or a mobile telephone. As shown in FIG. 1, the memory controller 101 and the storage area unit 108 are connected with, for example, a data bus D2.

As shown in FIG. 1, the memory controller 101 includes an external I/F unit 102, a data-continuity management unit 103, a card information management unit 104, a control unit 105, a storage area I/F unit 106, an address information management unit 107, and a bus B2. As shown in FIG. 1, the functional units of the memory controller 101 are connected to one another with the bus B2. Alternatively, some or all of the functional units of the memory controller 101 may be connected directly.

The external I/F unit 102 is connected to a module accessing unit 112 included in the access module 110 with the transmission line D1. The external I/F unit 102 can transmit and receive various types of information or data including commands and data to and from an access module corresponding to the information recording module 100 (an access module of a device such as a player or a recorder).

The data-continuity management unit 103 manages information indicating whether data transmitted from the access module 110 and managed in the storage area unit 108 is continuous to have a predetermined length or more, or more specifically whether the data constitutes a part of continuously managed data (continuous data) having a predetermined length or more. The “continuous data having a predetermined length or more” refers to data that extends continuously to have a predetermined length or more in a logical address space that can be managed by the access module 110.

The card information management unit 104 manages information about various parameters (access information) associated with an optimum access method that is used when the access module 110 accesses the information recording module 100.

The control unit 105 controls processing for writing and reading data in accordance with a command received from the access module 110 to control the internal processing of the information recording module 100.

The storage area I/F unit 106 is connected to the storage area unit 108, and functions as an interface via which the control unit 105 or the like writes or reads data to or from the storage area unit 108.

The address information management unit 107 manages address information indicating the correspondence between physical addresses of data managed by the storage area unit 108 and logical addresses at which the access module 110 accesses to obtain the data stored at the physical addresses. For example, the address information management unit 107 may have a logical-to-physical address conversion table, and convert a logical address to a physical address or a physical address to a logical address using the logical-to-physical address conversion table.

The storage area unit 108 may be, for example, a recording element for recording data. More specifically, the storage area unit 108 may be formed using a hard disk, an optical disc, or a nonvolatile memory.

Although the present embodiment describes the case in which the storage area unit 108 is formed using a nonvolatile memory, the present invention should not be limited to this structure. The nonvolatile memory is formed by a nonvolatile data recording element, or is formed by, for example, a semiconductor recording element such as a NAND-type flash element. To write data to a NAND-type memory, the NAND-type memory first needs to be reset to an unrecorded status by erasing data that has been recorded on the memory. Data recorded on the NAND-type memory is erased in units called “erase blocks”, each of which consists of a plurality of physical pages, or minimum units for writing (each having, for example, 512 bytes). Each erase block is typically composed of 2̂i (2 raised to the i-th power (i is an integer greater than or equal to 0)) continuous physical page areas.

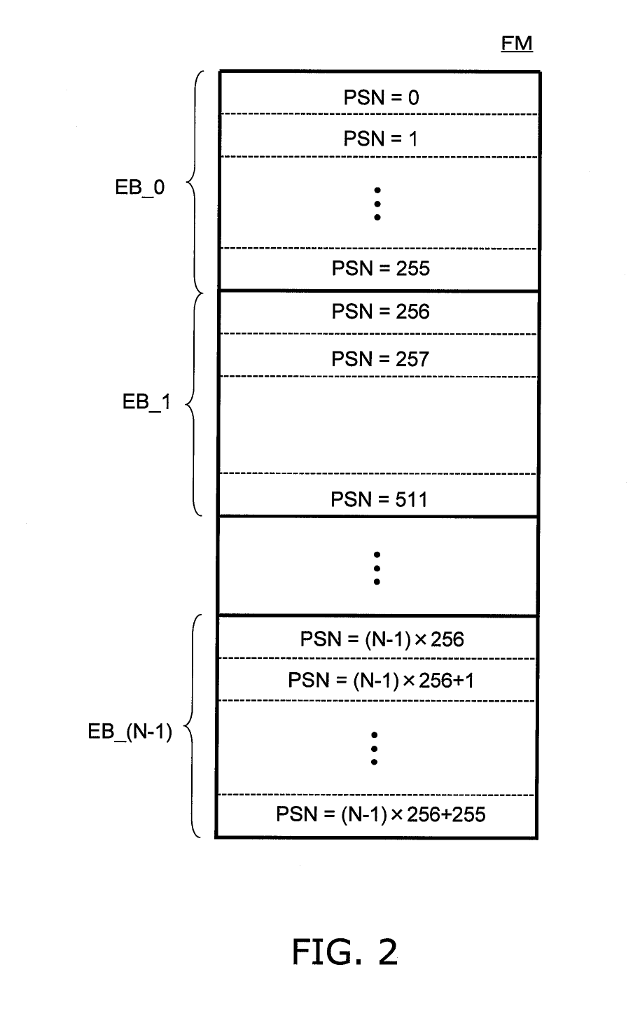

FIG. 2 shows one example of the relationship between erase blocks and pages of a flash memory FM. In the example shown in FIG. 2, the flash memory FM includes N erase blocks EB, namely, erase blocks EB_0 to EB (N−1). A single erase block has a size of, for example, 128 KB. A single erase block consists of 256 pages. The pages of the erase blocks are given serial physical page numbers PSN from PSN=0 to PSN=(N−1)×256+255. Data can be written and read in units of pages, whereas old data needs to be erased in units of erase blocks (128 KB) before new data is written.

### 1.1.2 Structure of Access Module

The access module 110 includes a control unit 111, a module accessing unit 112, an access function unit (access module side software) 113, and a bus B1.

As shown in FIG. 1, the functional units of the access module 110 are connected to one another with the bus B1. Alternatively, some or all of the functional units of the access module 110 may be connected directly.

As shown in FIG. 1, the access function unit includes an application unit (application program) 114, a file system control unit 115, an access condition determination unit 116, and an access control unit 117.

Although the present embodiment describes the case in which the access function unit 113 is implemented using software, the present invention should not be limited to this structure. All or part of the access function unit 113 may be implemented using hardware.

The control unit 111 controls the access module 110. The control unit 111 executes various controls or specifically transmits a command for writing or reading data to or from the information recording module 100 or executes the access module side software (access function unit).

The module accessing unit 112 is connected to the external I/F unit 102 included in the information recording module 100 with the transmission line D1, via which the module accessing unit 112 communicates with the information recording module 100. The module accessing unit 112 passes information between the access module 110 and the information recording module 100 via the transmission line D1.

The access module side software (access function unit) 113 is mainly composed of the application program (application unit) 114, the file system control unit 115, the access condition determination unit 116, and the access control unit 117. The access module side software (access function unit) 113 is stored in a storage area like a ROM (not shown) included in the access module 110. The access module side software 113 is loaded into the RAM area (not shown) and executed when the access module 110 (or the information recording system 1000) is powered on.

The application program (application unit) 114 performs data processing in accordance with a processing target of each application, and writes or reads the target data to or from the information recording module 100 via the file system control unit 115.

The file system control unit 115 manages data stored in the information recording module 100. For example, the file system control unit 115 executes data control to read and write data in accordance with a file system format defined by a predetermined standard, such as FAT12/16 or FAT32.

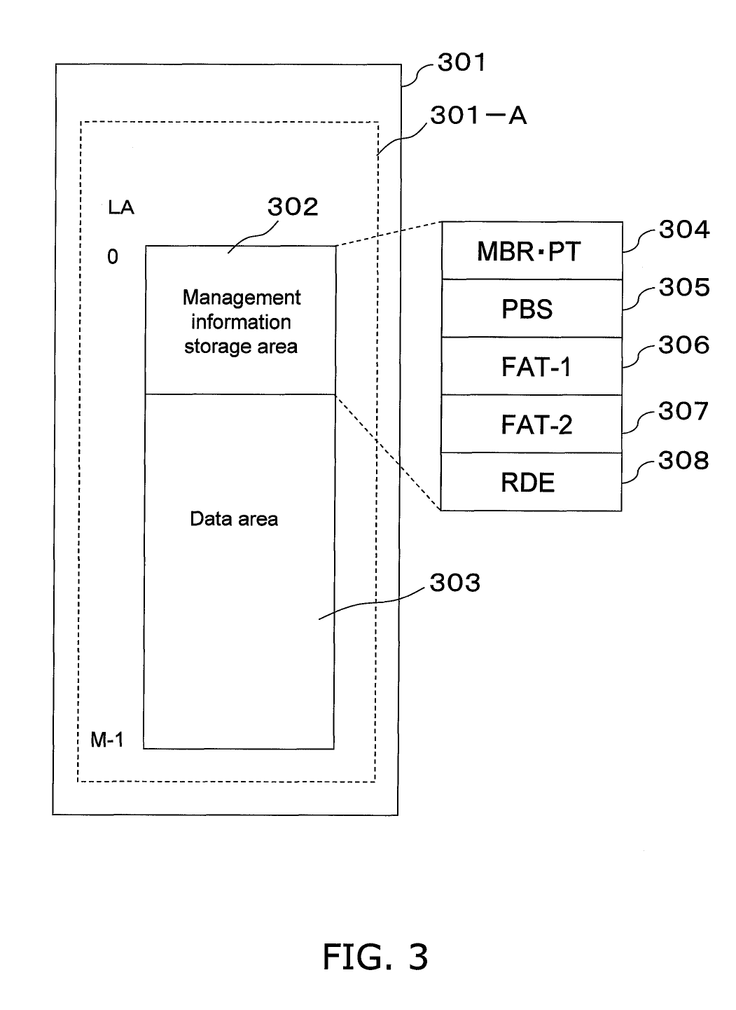

One structure of the FAT file system used by the information recording module 100 will now be described with reference to FIG. 3.

A file system management area 301-A shown in FIG. 3 forms an area of the storage area unit 108 shown in FIG. 1 that is managed under the file system. The file system management area 301-A forms either the entire area of the storage area unit 108 or a part of the area of the storage area unit 108. In FIG. 3, LA indicates a logical address. Under the FAT file system, at the beginning of the file system management area 301-A is a management information storage area 302, which stores information for managing the entire file system management area. The management information storage area 302 is then followed by a data area 303, which stores file data etc. The management information storage area 302 includes a master boot record and a partition table (partition tables) therein (hereafter referred to as “MBR-PT”) 304, a partition boot sector (PBS) 305, an FAT-1 306 and an FAT-2 307 (the two FATs may hereafter be collectively referred to as the FAT), and a root directory entry (RDE) 308.

The MBR-PT 304 stores information used to manage the file system management area by dividing it into a plurality of areas called partitions.

The PBS 305 stores information about management within each partition.

The FATs 306 and 307 are significant areas storing information about the logical storage positions of file data. The file system management area typically has two FATs each of which stores the same information, and thus the file system is a duplicated file system.

The data area 303 is managed in units of divisional areas called clusters, each of which stores file data. A file storing a large amount of data uses a plurality of clusters to store the data. The FAT-1 306 and the FAT-2 307 store link information indicating links between clusters.

The RDE 308 stores information about files and directories that are immediately below the root directory.

The access condition determination unit 116 checks an access condition read from the information recording module 100 and determines an access condition to be used for storing data.

The access control unit 117 functions as a driver corresponding to the module accessing unit 112. Also, the access control unit 117 changes the format of data managed by the file system control unit 115 to a predetermined command format to enable data communication between the access module 110 and the information recording module 100. More specifically, the access control unit 117 converts the data format of a file system layer to the data format of a physical layer.

### 1.2 Operation

### 1.2.1 Data Writing Process

A sequence of processing for data writing performed between the information recording module 100 and the access module 110 included in the information recording system 1000 described above will now be described.

### 1.2.1.1 Data Writing Process (by Access Module 110)

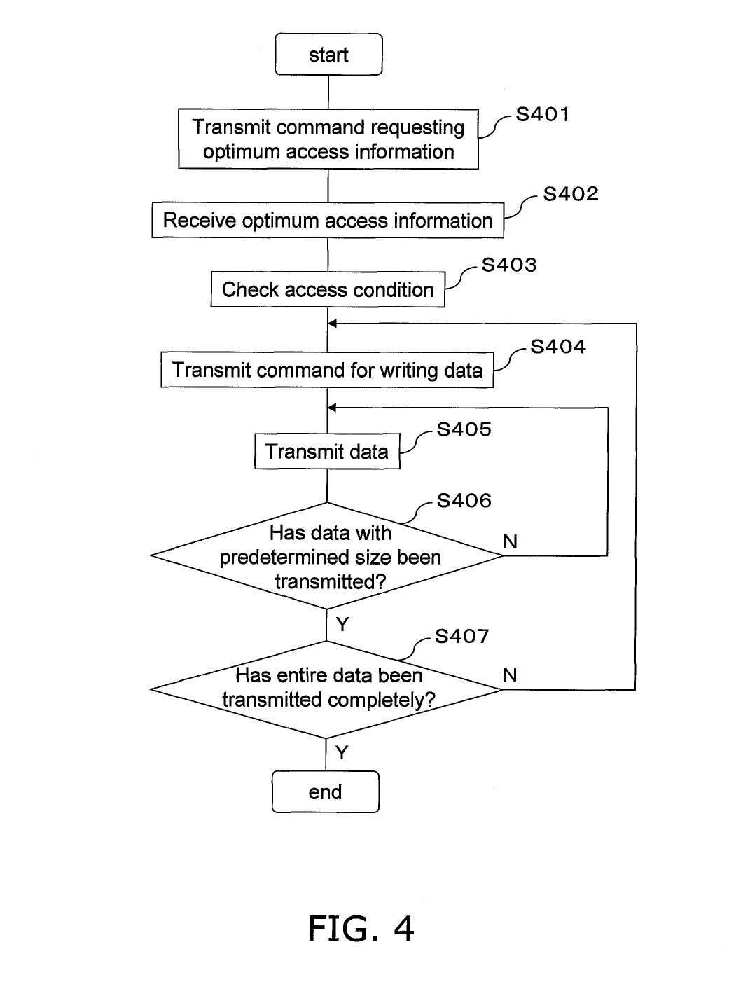

FIG. 4 is a flowchart showing an example of processing performed by the access module 110 when recording data into the information recording module 100. The processing performed by the access module 110 when recording data into the information recording module 100 will now be described with reference to the flowchart shown in FIG. 4.

### Step S401:

The control unit 111 transmits a command (access information requesting command) requesting access information, which is used to obtain an optimum access condition from the information recording module 100, to the information recording module 100 via the module accessing unit 112.

### Step S402:

The control unit 111 receives access information from the information recording module 100 via the module accessing unit 112.

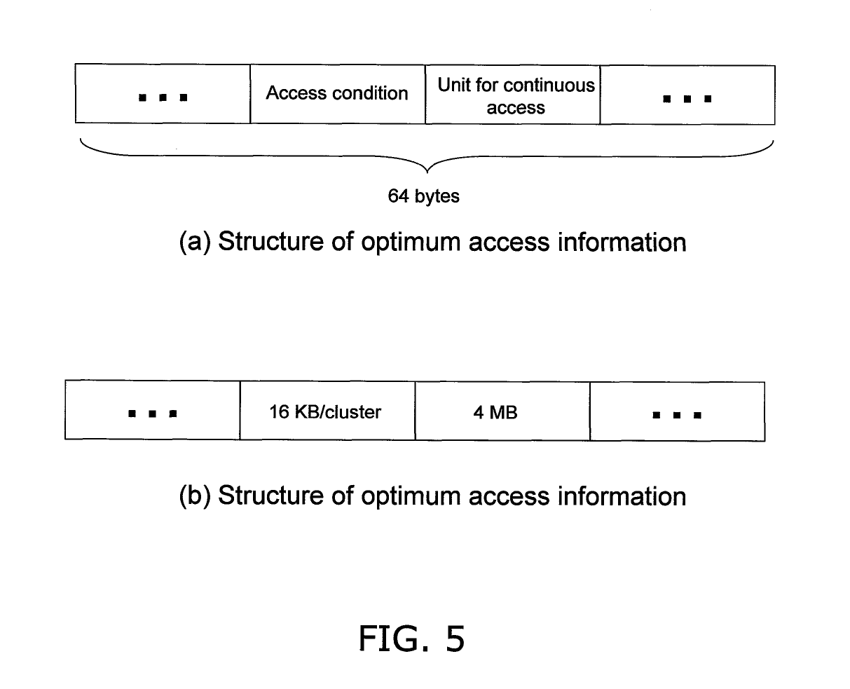

FIGS. 5A and 5B show one structure of the access information that is received by the control unit 111. As shown in FIG. 5A, the access information has 64 bytes, and consists of information indicating an access condition and information indicating the unit for continuous access. The structure of the access information shown in FIG. 5A is a mere example, and the present invention should not be limited to this structure. FIG. 5B shows specific values used in this structure (the structure of the optimum access information). The access information shown in FIG. 5B consists of a value of 16 KB/cluster as the access condition and a value of 4 MB as the unit for continuous access.

The access information with this structure (the access information shown in FIG. 5B) indicates that data of 4 MB stored continuously into clusters each having 16 KB in the logical address space in the information recording system 1000 is managed in a logically continuous manner in the information recording module 100.

Although not shown, the access information may have another structure. For example, the access information may consist directly of the value indicated by the existing access information or for example the value of the information indicating the access performance, and may additionally include only bit information of either 0 or 1 indicating whether the module is capable of storing data-continuity information, or information indicating that data is continuous in the logical address space. Also, although the access information has 64 bytes in the above example, the access information may have another size.

### Step S403:

The access condition determination unit 116 reads the access condition received from the information recording module 100, and checks the access condition.

The term “checking the access condition” may refer to determining whether the access condition indicated by the access information is usable based on the access information having the structure shown in FIGS. 5A and 5B.

When, for example, the access information indicates the same condition as the access condition assumed by the access condition determination unit 116, the access condition determination unit 116 determines that an access based on the value of the access information is to be enabled. When the access information indicates an access condition that is not assumed by the access condition determination unit 116, the access condition determination unit 116 determines that an access failing to satisfy the access condition (access condition indicated by the access information) is to be disabled.

### Step S404:

The file system control unit 115 transmits a command for causing a writing process (data writing command) to the information recording module 100 via the module accessing unit 112. An argument is set in the data writing command transmitted by the access module 110 to designate a first logical address at which the data storage is to be started in the information recording module 100.

The file system control unit 115 executes, for example, control to update file system management information (write data) after data having a size satisfying the access condition is written based on parameters such as clusters, which are units for writing data, the access condition checked by the access condition determination unit 116, the file system structure of data that has already been recorded on the information recording module 100, and the size of data to be written and the speed at which data is written requested by the application program 114. More specifically, the file system control unit 115 executes control associated with the data writing process using an optimum condition based on the size of data to be written, the first logical address in the information recording module 100 at which the data writing is to be started, and the order of logical addresses at which the data is written in a manner to enable an optimum access assumed in advance. The file system control unit 115 then transmits a data writing command to the information recording module 100 via the access control unit 117 and the module accessing unit 112.

### Step S405:

The access control unit 117 transmits data to the information recording module 100 via the module accessing unit 112. The file system control unit 115 processes data in units of clusters, whereas the access control unit 117 processes data in units of data blocks (for example, in units of 512 bytes) instead of clusters. Thus, data is transmitted from the module accessing unit 112 in units of data blocks.

### Step S406:

The access control unit 117 determines whether the size of the data transmitted has reached a predetermined size. The “predetermined size” refers to a size of data managed in units of, for example, clusters. When determining that the size of the data transmitted has yet to reach the predetermined size, the access control unit 117 again transmits data having a data block size in step S405.

### Step S407:

The file system control unit 115 determines whether the entire data has been transmitted completely. When the entire data has yet to be transmitted completely, the file system control unit 115 again transmits a data writing command in step S404. A logical address value etc. set in the data writing command is subjected to the same determination as described for the processing in step S404.

### 1.2.1.2 Data Writing Process (by Information Recording Module 100)

The processing performed by the information recording module 100 will now be described.

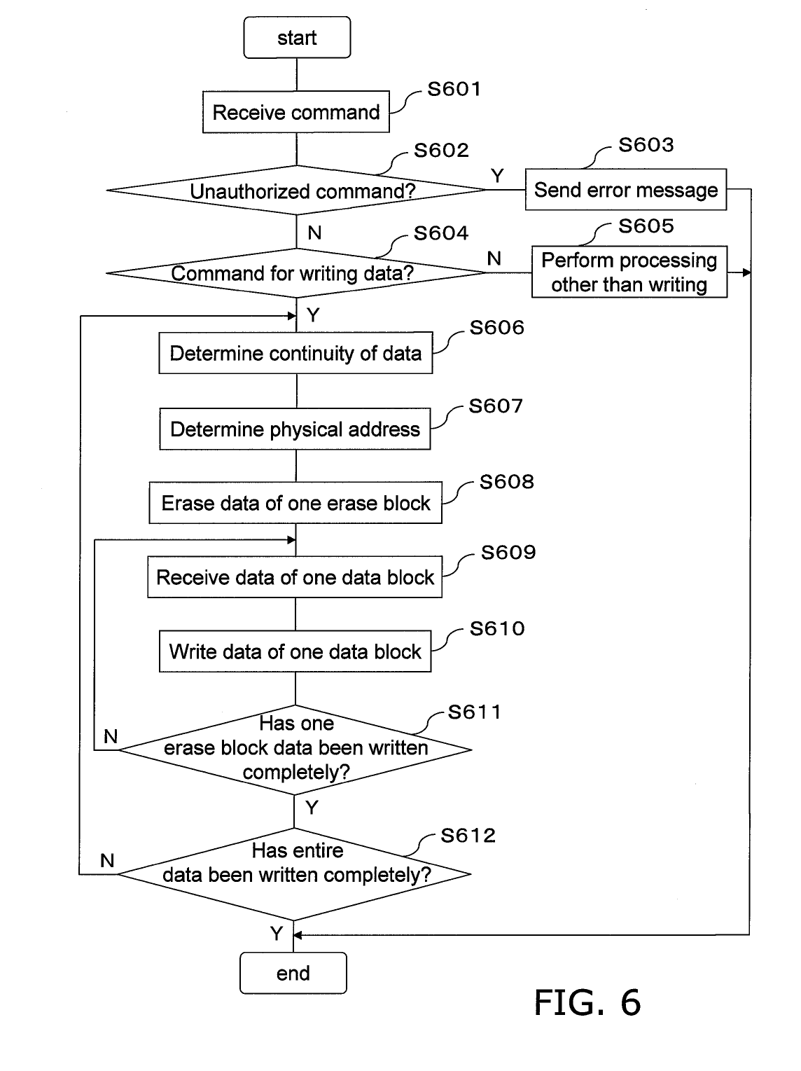

FIG. 6 is a flowchart showing a data writing process performed by the information recording module 100. FIG. 6 shows one example of the data writing process, and shows a sequence of internal processing performed by the information recording module 100 when writing data having a length corresponding to a multiple of an erase block for ease of explanation. The data writing process performed by the information recording module 100 will now be described with reference to the flowchart shown in FIG. 6.

### Step S601:

The memory controller 101 receives a command with an argument transmitted from the access module 110 via the external I/F unit 102.

### Step S602:

The control unit 105 refers to the received command, and determines whether the command is an unauthorized command that cannot be recognized.

### Step S603:

When determining that the command received by the information recording module 100 is an unauthorized command in step S602, the control unit 105 sends an error message to the access module 110 via the external I/F unit 102.

### Step S604:

When determining that the command received by the information recording module 100 is recognizeable in step S602, the control unit 105 further determines whether the command is a data writing command.

### Step S605:

When determining that the command received by the information recording module 100 is not a data writing command in step S604, the control unit 105 performs processing requested by the received command. When, for example, the received command is a command requesting access information, the control unit 105 reads access condition information from the card information management unit 104, and transmits the read information to the access module 110.

### Step S606:

When determining that the received command is a data writing command in step S604, the control unit 105 determines whether the data requested by the data writing command is continuous. The processing performed in this case will be described later.

### Step S607:

The control unit 105 determines a physical address of an erase block at which data is actually to be written in the storage area unit 108.

### Step S608:

The control unit 105 erases data stored in a physical block of the storage area unit 108 that has been determined as an erase block in step S606 via the storage area I/F unit 106.

### Step S609:

The control unit 105 receives data having a size of a single data block from the access module 110 via the external I/F unit 102.

### Step S610:

When completing the data reception, the control unit 105 writes the received data having the single data block size into the storage area unit 108 via the storage area I/F unit 106. The address information management unit 107 stores the correspondence between the logical address designated by the access module 110 and the physical address of the storage area unit 108 at which the data has actually been written.

### Step S611:

The processing for receiving and writing data in steps S609 and S610 is performed repeatedly until the data of the single erase block is written completely.

### Step S612:

The processing for writing data of a single erase block in steps S606 to S610 is performed repeatedly until the data having the size designated by the access module 110 is written completely. When the data having the size designated by the access module 110 is written completely, the processing ends.

### 1.2.2 Data Continuity Determination

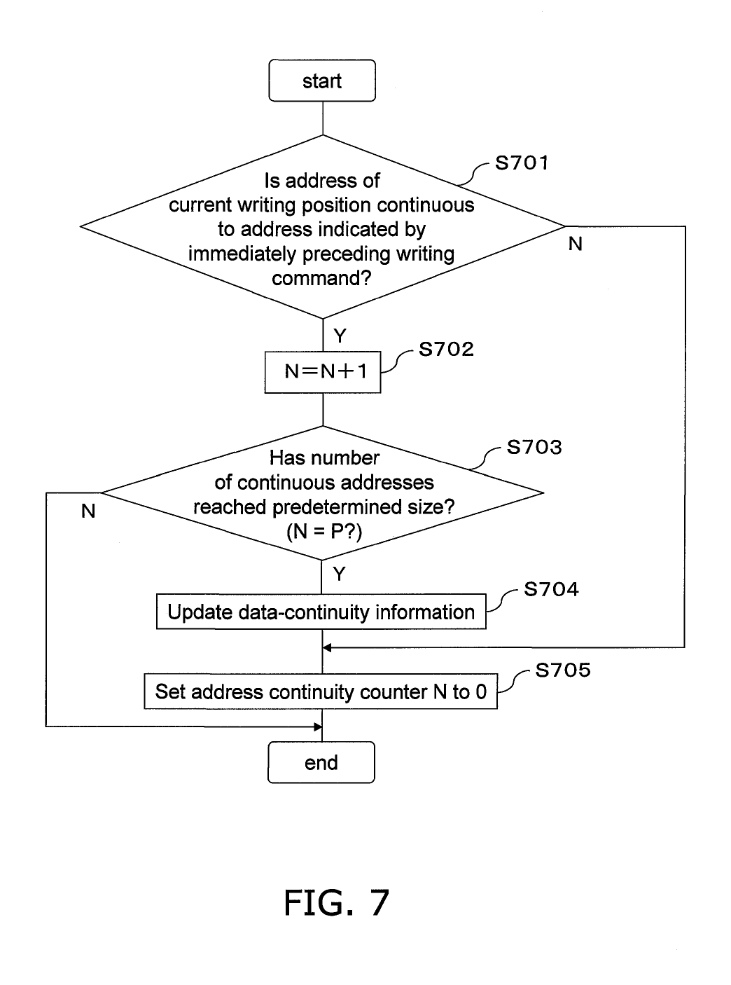

The processing for determining continuity of data in step S606 in the above data writing process will now be described. FIG. 7 is a flowchart showing one example of the processing for determining data continuity performed in step S606 included in the above data writing process. The processing for determining data continuity performed in step S606 will now be described with reference to FIG. 7.

### Step S701:

The control unit 105 determines whether a logical address at which data is to be written indicated by a data writing command transmitted from the access module 110 is continuous to a logical address of data that has been written in the immediately preceding writing process. When determining that the logical address at which data is to be written is not continuous to the logical address of data written in the immediately preceding writing process, the control unit 105 advances to the processing in step S705, which will be described later.

### Step S702:

When determining that the logical address at which data is to be written is continuous to the logical address of data written in the immediately preceding writing process, the control unit 105 assumes that the data is continuous, and increments the value of a variable N. Although not shown, the variable N is initialized to 0 in the initialization process or the like of the information recording module 100.

### Step S703:

The control unit 105 determines whether the number of continuous logical addresses has reached a predetermined size. More specifically, the control unit 105 performs this determination based on whether the variable N is larger or smaller than (or equal to) a preset value P indicating a predetermined continuity of data. When the variable N is smaller than the value P (when the number of continuous logical addresses has yet to reach the predetermined size), the control unit 105 ends the processing.

### Step S704:

When determining that the number of continuous logical addresses has reached the predetermined size in step S703, the control unit 105 updates data-continuity information stored in the data-continuity management unit 103. In one example, the predetermined size is 4 MB, and the single cluster size is 16 KB. In this case, the control unit 105 updates the data-continuity information when determining that the variable N has been incremented to 254 in step S703.

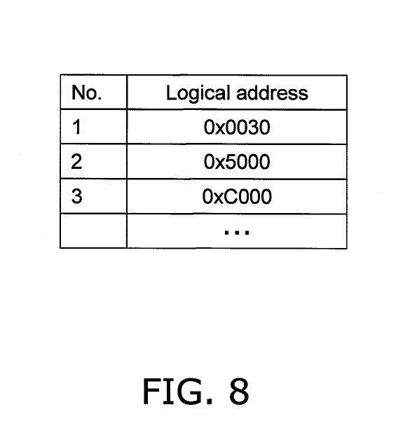

FIG. 8 shows one example of the data-continuity information. The data-continuity information shown in FIG. 8 servers as a list of pieces of information each indicating a first logical address storing a beginning portion of data when the data continuous up to 4 MB is written in units of 512-byte data blocks. For example, the logical address of 0x0030 with No. 1 in FIG. 8 indicates that data is stored continuously at logical addresses corresponding to 4 MB from the first logical address of 0x0030 to the logical address of 0x2030. In the same manner, the logical address of 0x5000 with No. 2 indicates that data is stored continuously at logical addresses from 0x5000 to 0x7000.

### Step S705:

The control unit 105 resets the variable N, which functions as a counter for counting addresses at which data is stored continuously, to zero.

As described above, the information recording module 100 determines whether data transmitted from the access module 110 constitutes a part of data stored at continuous logical addresses based on the predetermined value, and stores information resulting from this determination into the data-continuity management unit 103.

Although the present embodiment describes the case in which the information recording system 1000 uses information indicating data continuity stored in the data-continuity management unit 103 when the data is stored at continuous logical addresses, the present invention should not be limited to this structure. When, for example, the information recording system 1000 manages data under the FAT file system, information indicating continuity of data (hereafter referred to as “data-continuity information”) may be stored into the data-continuity management unit 103 after the data is stored and the management information or the FAT information corresponding to the data is determined to have been updated correctly. In other words, the data-continuity information may be stored after its agreement with the management information is determined.

### 1.2.3 Data Reading Process

A sequence of processing for data reading performed between the information recording module 100 and the access module 110 included in the information recording system 1000 of the present invention will now be described.

For ease of explanation, system information about the FAT file system, such as information about FAT entries, is assumed to have been read by the access module 110 in advance. A sequence of processing only for reading data, and in particular a sequence of such processing that requires seeks will now be described.

### 1.2.3.1 Data Reading Process (by Access Module 110)

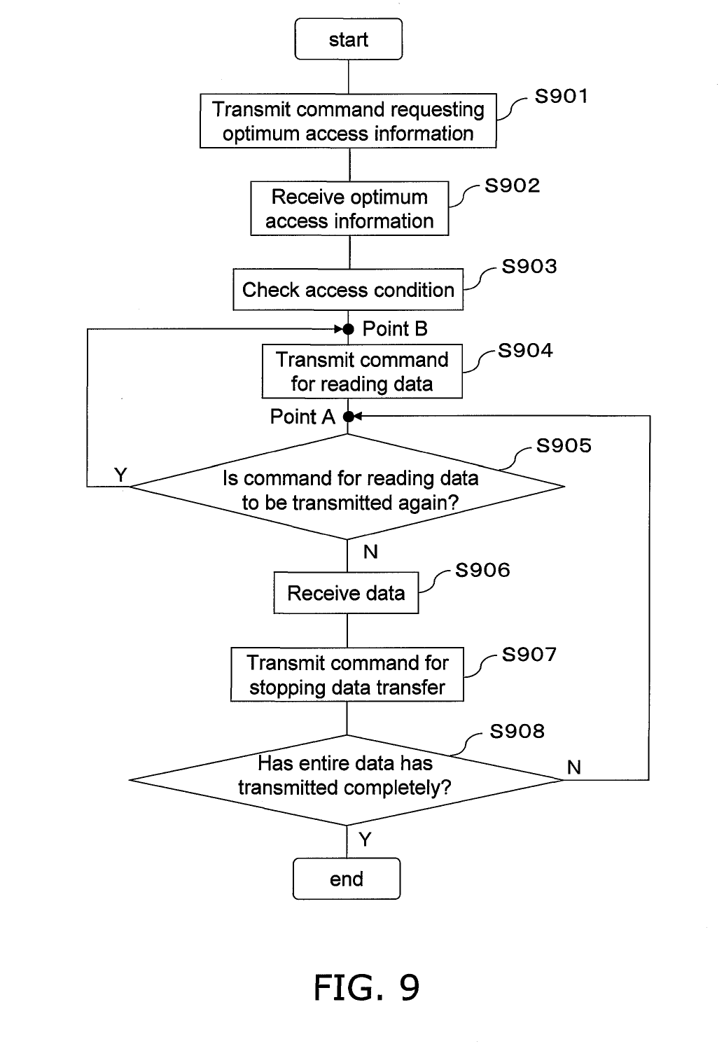

FIG. 9 is a flowchart showing an example of processing performed by the access module 110 when reading data. The processing performed by the access module 110 when reading data will now be described with reference to FIG. 9.

### Step S901:

The control unit 111 transmits a command (access information requesting command) requesting access information, which is used to perform an optimum access, to the information recording module 100 via the module accessing unit 112.

### Step S902:

The control unit 111 receives access information from the information recording module 100, which is transmitted in response to the command transmitted in step S901.

### Step S903:

The access condition determination unit 116 reads the received access information, and checks the access information, such as parameter setting used when an FAT entry is read. The access condition determination unit 116 checks the access information specifically by determining whether the received access information is usable. When, for example, the access information indicates continuous logical addresses corresponding to 4 MB, the access condition determination unit 116 determines whether information indicating the data continuity is included. When determining that the continuity indicative information is included, the access condition determination unit 116 may determine, for example, that the logical address space corresponding to 4 MB can be skipped when an FAT entry is read.

### Step S904:

The file system control unit 115 refers to the FAT entry via the access control unit 117, and transmits, to the information recording module 100, a command with which the access control unit 117 reads data having a single data block size from the corresponding cluster. The file system control unit 115 sets an argument in the transmitted data reading command to indicate a first logical address of the information recording module 100 at which the data reading is to be started.

### Step S905:

The file system control unit 115 determines whether to again transmit a command for reading only data of a single data block or to transmit a command for reading data of a plurality of data blocks based on, for example, a response to the command transmitted in step S904, the access condition, and the designated data to be read. The processing in step S905 will be described in detail later.

### Step S906:

The access control unit 117 receives data transmitted from the information recording module 100 in response to the data reading command transmitted in step S905. The access control unit 117 receives the data in units of data blocks.

### Step S907:

The access control unit 117 transmits a command for stopping data transfer when the size of data received reaches a predetermined size. The predetermined size may be, for example, a size of data in units of clusters, each of which consists of a plurality of data blocks transferred from the information recording module 100.

### Step S908:

When the size of data received reaches a predetermined size, the file system control unit 115 determines whether the entire data has been received completely. When the entire data has yet to be received completely, the file system control unit 115 again transmits a data reading command to the information recording module 100 in step S905.

### Structure of Link Information Indicating Link Between Clusters Etc. in Fat File System

The structure of link information indicating links between clusters etc. used in the FAT file system will now be described.

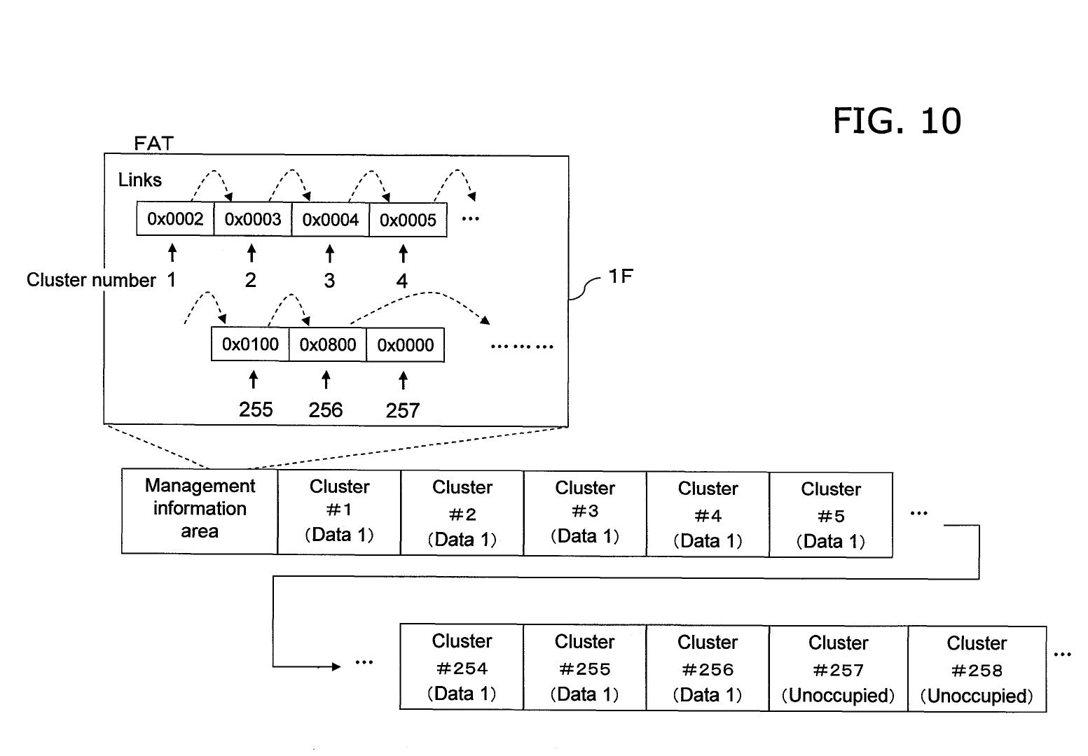

One structure of data managed under the FAT file system will now be described with reference to FIG. 10.

In the FAT file system, the data areas are managed in fixed-length data units called clusters. In FIG. 10, the clusters are given ascending cluster numbers starting from 1.

An area FAT 1F included in the management information area stores information about the use status of each cluster and link information indicating links between clusters (arrows drawn using broken lines in the area FAT 1F). The area FAT 1F consists of FAT entries to which cluster numbers (numbers indicated by arrows drawn with solid lines in the area FAT 1F) are assigned.

Each FAT entry can have a size of one of 12 bits, 16 bits, and 32 bits per cluster depending on the type of the FAT file system. In the example shown in FIG. 10, each FAT entry is expressed using 16 bits. Each FAT entry stores one of a cluster number of a cluster linked to the corresponding cluster, a value of 0x0000 indicating that the corresponding cluster is an unoccupied area, and a value of 0xFFFF indicating that the corresponding cluster is the last cluster that has no link. In the enlarged portion in FIG. 10 (upper portion in FIG. 10), FAT entries with cluster numbers of 1 to 256 are pointed by pointers 1 to 256. In this example, data is stored in a continuous manner in clusters with the cluster numbers of 1 to 256. In this example, when the size of each cluster is 16 KB, data of 4 MB (=16 KB×256) is stored at continuous logical addresses. Additionally, the 256^{th} FAT entry stores data of the following FAT entry. As a result, data of more than 4 MB is stored at continuous logical addresses.

### Sequence of Processing for Determining Whether to Transmit Data Reading Command

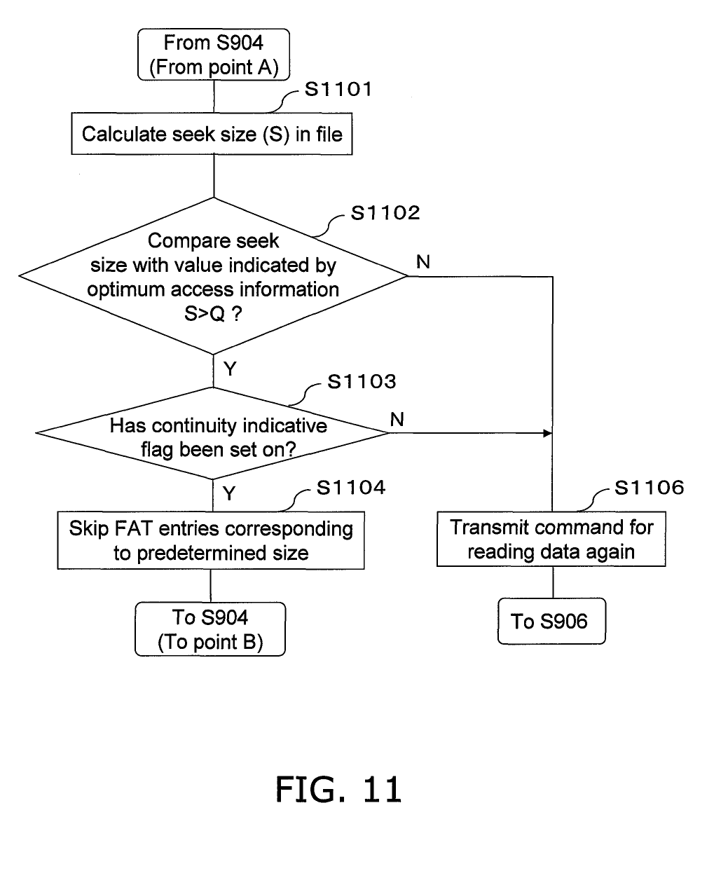

FIG. 11 shows a sequence of processing for determining whether to transmit a data reading command in step S905 for data managed under the FAT file system. The sequence of processing for determining whether to transmit a data reading command in step S905 will now be described with reference to FIG. 11.

### Step S1101:

The file system control unit 115 calculates a size (seek size (S)) of a seek, which is performed in a file in units of clusters, based on designation by the application program 114.

### Step S1102:

The file system control unit 115 compares the calculated seek size with the unit for continuous access (Q) indicated by access information.

The information recording module 100 may store access information indicating 4 MB as the unit for continuous access as shown in FIG. 5B. In this case, when data of 4 MB is written at continuous addresses, the information recording module 100 sets a continuity indicative flag on in a command transmitted in response to the data reading command. When, for example, a continuity indicative flag is set on in a data reading command for reading the first 512-byte data, the continuity indicative flag indicates that data of FAT entries corresponding to 4 MB are thereafter stored continuously. To read data of, for example, a target FAT entry that is away from the first data reading position by 4 MB or more, a seek performed between the first data reading position and the target FAT entry may be skipped. The file system control unit 115 determines whether the continuity indicative flag included in the response command is to be used for the above processing by determining whether the seek size (S) from the current pointer is greater than the size of the continuous access (unit for continuous access (Q)).

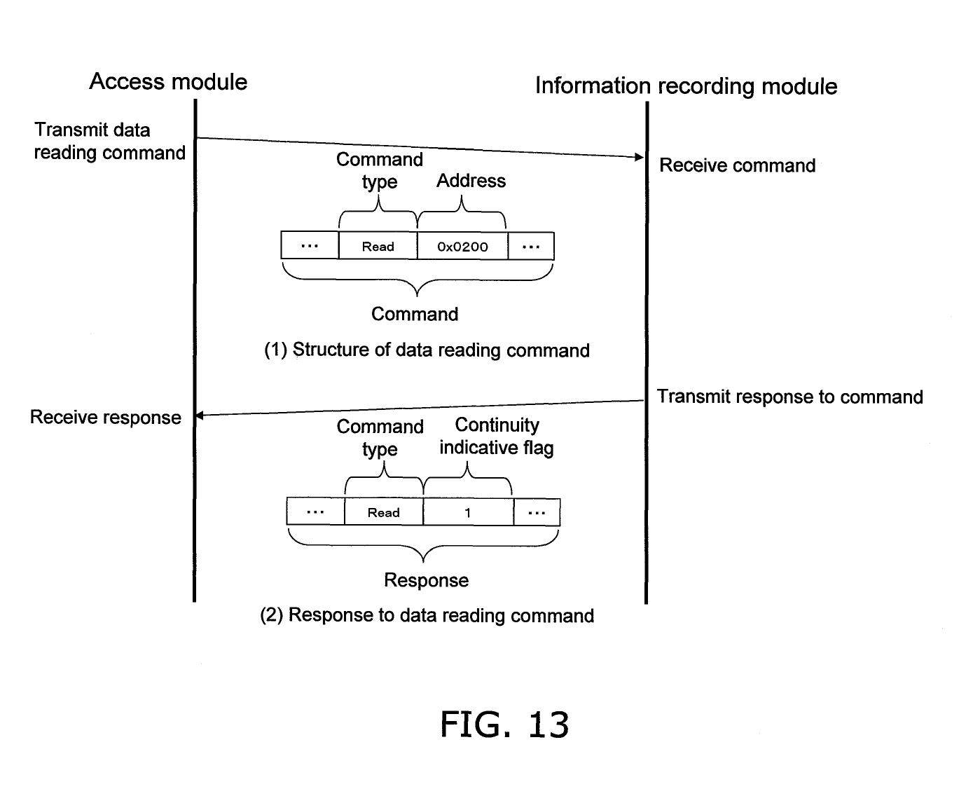

One structure of the continuity indicative flag will now be described with reference to FIG. 13.

When the seek size (S) is smaller than the unit for continuous access (Q), the file system control unit 115 searches FAT entries corresponding to the seek size, and transmits a command for reading a plurality of data blocks to the information recording module 100 (step S1106). The processing in step S906 is then performed.

### Step S1103:

When the seek size is greater than the unit for continuous access (Q), the file system control unit 115 determines whether the continuity indicative flag is set on in a command transmitted in response to the data reading command, which has been transmitted to the information recording module 100 in step S904. When the continuity indicative flag is not set on, the file system control unit 115 transmits a command for reading a plurality of data blocks to the information recording module 100 (step S1106). The processing in step S906 is then performed.

### Step S1104:

When the continuity indicative flag is set on in the response command, the file system control unit 115 performs the processing of skipping FAT entries corresponding to a predetermined size, and calculates an address of a cluster from which data is to be read next.

When, for example, the access information returned by the information recording module has the structure shown in FIG. 5B, the access information indicates that data of 4 MB has been stored continuously. In this case, the file system control unit 115 can skip FAT entries corresponding to the data size of 4 MB and can search FAT entries following the skipped FAT entries. More specifically, the data having the structure shown in FIG. 10 may be used. In this case, when the cluster number of 1 is the first seek position and the required seek size is 4 MB or more, the file system control unit 115 can skip FAT entries corresponding to the data size of 4 MB or more. More specifically, the file system control unit 115 can skip FAT entries up to the management information position indicated by the cluster number of 256.

### 1.2.3.2 Data Reading Process (by Information Recording Module 100)

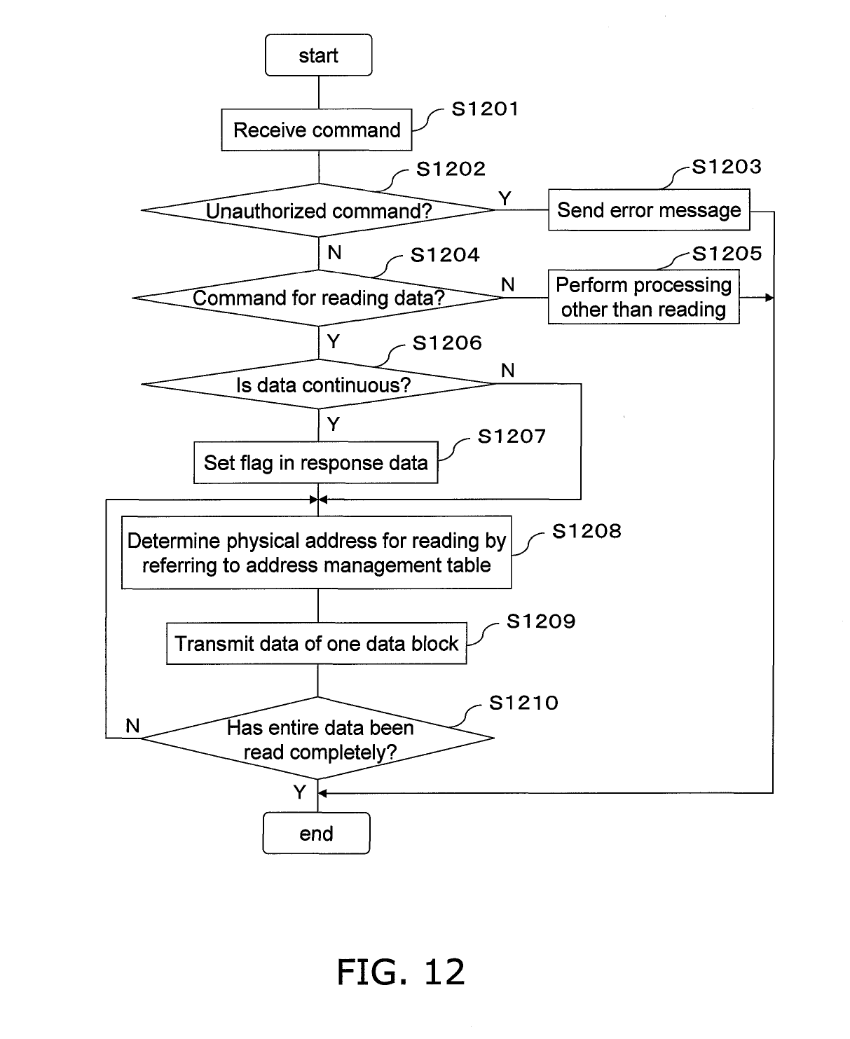

A sequence of processing performed by the information recording module 100 when data is read will now be described with reference to FIG. 12.

### Step S1201:

The control unit 105 receives a command with an argument transmitted from the access module 110 via the external I/F unit 102.

### Step S1202:

The control unit 105 refers to the command received from the access module 110, and determines whether the command is an unauthorized command that cannot be recognized.

### Step S1203:

When determining that the command received from the access module 110 is an unauthorized command in step S1202, the control unit 105 sends an error message to the access module 110 via the external I/F unit 102.

### Step S1204:

When determining that the command received from the access module 110 is recognizeable in step S1202, the control unit 105 further determines whether the command is a data reading command.

### Step S1205:

When determining that the command is not a data reading command in step S1204, the control unit 105 performs processing requested by the received command. When, for example, the received command is a command requesting access information, the control unit 105 transmits access condition information to the access module 110.

### Step S1206:

When determining that the received command is a data reading command in step S1204, the control unit 105 refers to information managed by the data-continuity management unit 103, and determines whether data designed by the data reading command is continuous, or more specifically whether the data constitutes a part of continuously managed data (continuous data) in the logical address space.

### Step S1207:

When determining that the data is continuous in step S1206, the control unit 105 sets the continuity indicative flag on in the data to be transmitted in response to the data reading command, and transmits the response data to the access module 110.

FIG. 13 shows a sequence of processing associated with transmission and reception of a data reading command and responses between the access module 110 and the information recording module 100.

The access module 110 transmits a data reading command READ including a designated address to the information recording module 100 ((1) in FIG. 13). When data stored at the designated address constitutes a part of continuous data, the information recording module 100 sets a continuity indicative flag on in data to be transmitted in response to the command, and transmits the response data to the access module 110 ((2) in FIG. 13).

### Step S1208:

Based on information indicating a logical address at which data is to be read, which is stored in an argument set in the command, the control unit 105 determines a physical address included in the storage area unit 108 by referring to the correspondence between logical addresses and physical addresses stored in the address information management unit 107.

### Step S1209:

The control unit 105 reads data from the physical address of the storage area unit 108 determined in step S1208, and transmits data of a single data block to the access module 110.

### Step S1210:

The control unit 105 repeatedly transmits data by repeating the processing from steps S1208 to S1209 until receiving a command for stopping data transfer from the access module (until transmitting the entire data completely).

In the information recording system 1000 described above, the information recording module 100 uses data-continuity information, which indicates continuity of data with a predetermined size or more that has been written at continuous addresses, and returns flag information indicating that data to be read constitutes a part of continuous data. This structure of the information recording system significantly reduces the overhead of the processing performed by the access module 110 when, for example, seeks to file data are performed under the FAT file system.

Although the present embodiment describes the structure of the information recording system 1000, the present invention should not be limited to the embodiment described above. The above embodiment may be modified without departing from the scope and spirit of the present invention. For example, the following modifications are possible.

(1) Although the present embodiment describes the case in which the information recording system 1000 includes only the single storage area unit 108 to store data into the information recording module 100, the present invention should not be limited to this structure. To improve the speed at which data is written into the recording area unit 108, for example, the information recording system 1000 may include a plurality of storage area units 108, and may store data dispersedly into pages of the storage area units 108 and may integrate erase blocks as necessary. In this manner, the processes described in the above embodiment may be performed using the more complicated data management method. In this case, the data managed by the data-continuity management unit 103 and the address information management unit 107 in the information recording system 1000 will have more complicated data structures than the structures described in the above embodiment. The data managed in the information recording system 1000 may have any data structure but only required to be managed as data with a predetermined size stored at continuous addresses designated by the access module 110.

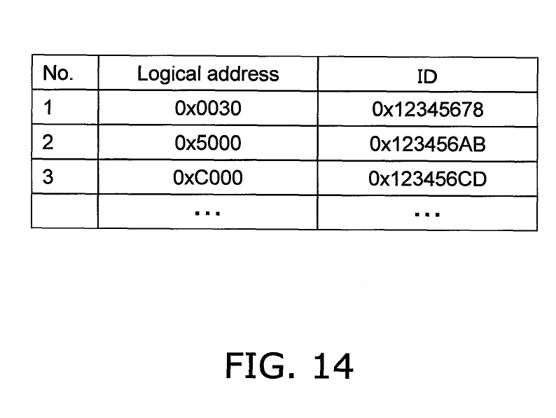

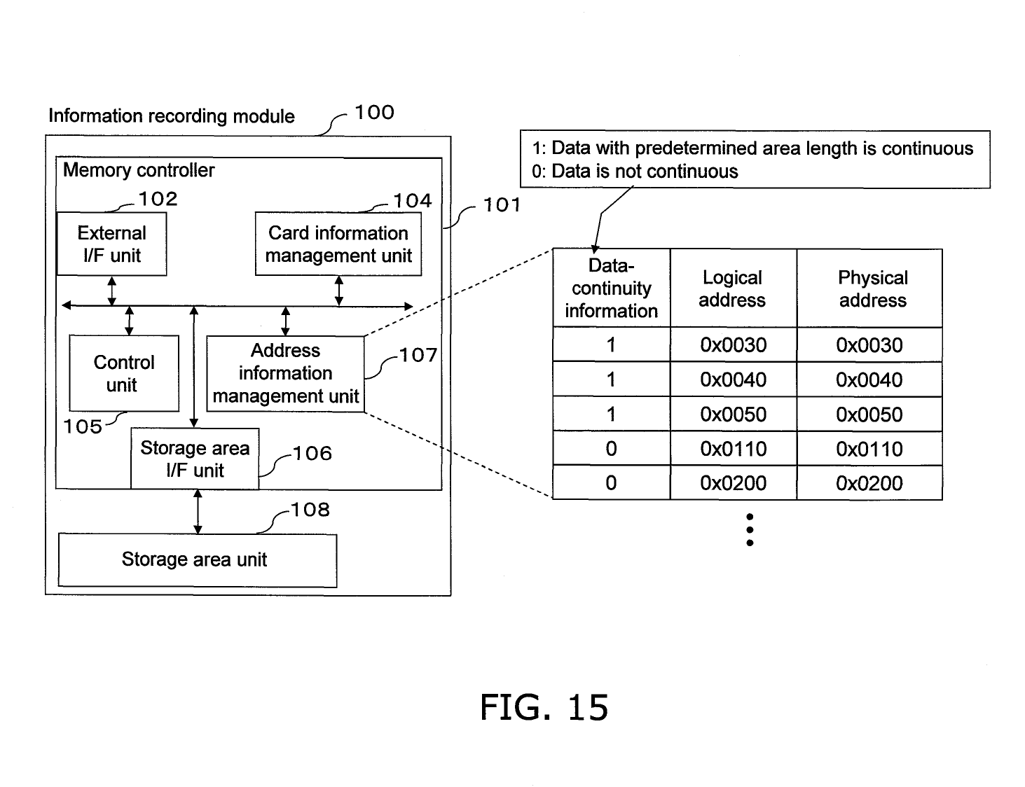

(2) Although the present embodiment describes the case in which the data-continuity management unit 103 manages continuous data using information about the continuity of data, the present invention should not be limited to this management method. As shown in FIG. 14, for example, the data-continuity management unit 103 may manage data-continuity information using ID information that uniquely identifies each piece of data-continuity information in addition to using logical addresses. When data is read, the information recording module 100 may return the response data together with ID information to the access module 110. Further, as shown in FIG. 15, the address information management unit 107, which manages the correspondence between logical addresses and physical addresses included in the storage area unit 108, may additionally store a continuity indicative flag indicating whether data having a predetermined area length is stored continuously for each pair of a logical address and a physical address.

### Second Embodiment

A second embodiment of the present invention will now be described.

An information recording system according to the second embodiment differs from the information recording system of the first embodiment in that the information recording system uses a command with which an information recording module 100 transmits data-continuity information to an access module 110 when data is read. More specifically, the information recording module 100 returns data-continuity information in response to a command requesting data-continuity information (data-continuity information requesting command) transmitted from the access module 110. The other structure of the information recording system of the second embodiment is basically identical to the structure of the information recording system of the first embodiment. The part of the information recording system of the second embodiment that differs from the information recording system of the first embodiment will be described in detail. The components of the information recording system of the present embodiment that are identical to the components in the above embodiment are given the same reference numerals as those components, and will not be described in detail.

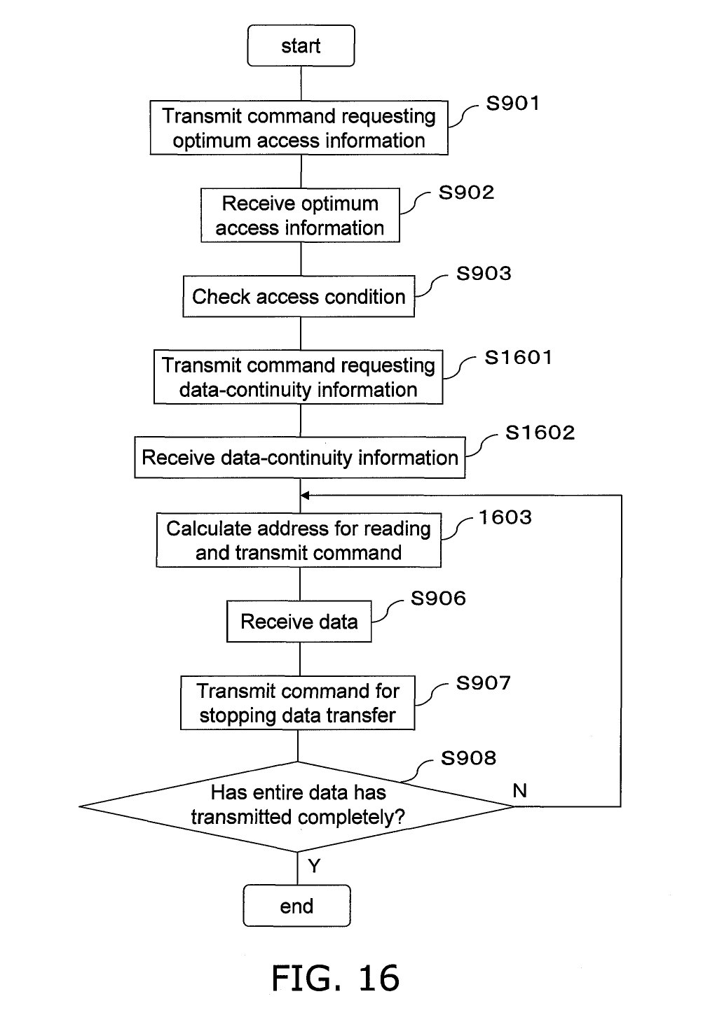

FIG. 16 is a flowchart showing an example of processing performed by the access module 110 when reading data. The processing differs from the processing shown in FIG. 9 in that step S905 for determining whether to transmit a data reading command again is eliminated and steps S1601 and S1602 are added, and step S904 for transmitting a command for reading data of a single data block is replaced by step S1603 for transmitting a command for reading data of a plurality of data blocks. The other part of the processing is identical to the processing shown in FIG. 9. Steps S1601, S1602, and S1603 will now be described.

### Step S1601:

The file system control unit 115 transmits a command requesting data-continuity information to the information recording module 100 via an access control unit 117.

### Step S1602:

The file system control unit 115 receives data-continuity information from the information recording module 100 via the access control unit 117.

### Step S1603:

Based on the received data-continuity information, the file system control unit 115 transmits a command for reading data of a plurality of blocks to the information recording module 100 via the access control unit 117.

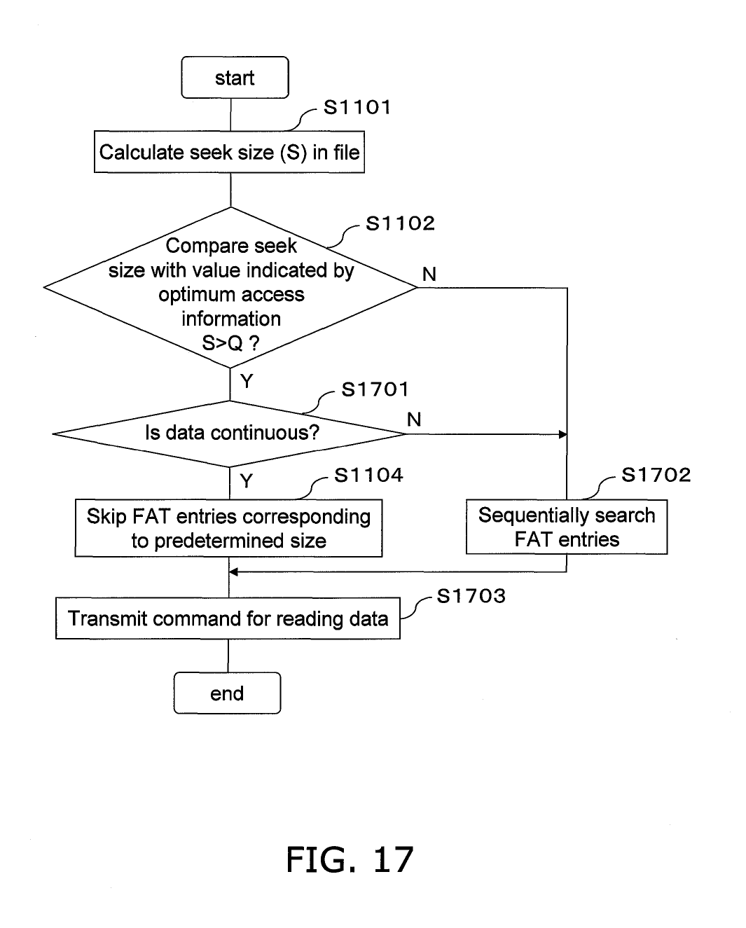

FIG. 17 is a flowchart showing the processing in step S1603 in more detail.

The processing shown in FIG. 17 differs from the processing shown in FIG. 11 in that step S1103 is replaced by step S1701, and steps S1702 and S1703 are added. The other part of the processing in FIG. 17 is identical to the processing shown in FIG. 11. Steps S1701, S1702, and S1703 will now be described.

### Step S1701:

The file system control unit 115 determines whether data to which a seek is currently to be performed is continuous or more specifically whether the data constitutes a part of continuous data based on the obtained data-continuity information.

### Step S1702:

When determining that the data to which a seek is currently to be performed is not continuous in step S1701, the file system control unit 115 sequentially searches FAT entries.

### Step S1703:

The file system control unit 115 determines an address of a cluster included in an FAT entry from which data is to be read, and transmits a command for reading data of a plurality of data blocks to the information recording module 100 via the access control unit 117.

### Sequence of Processing for Data Reading in Information Recording System

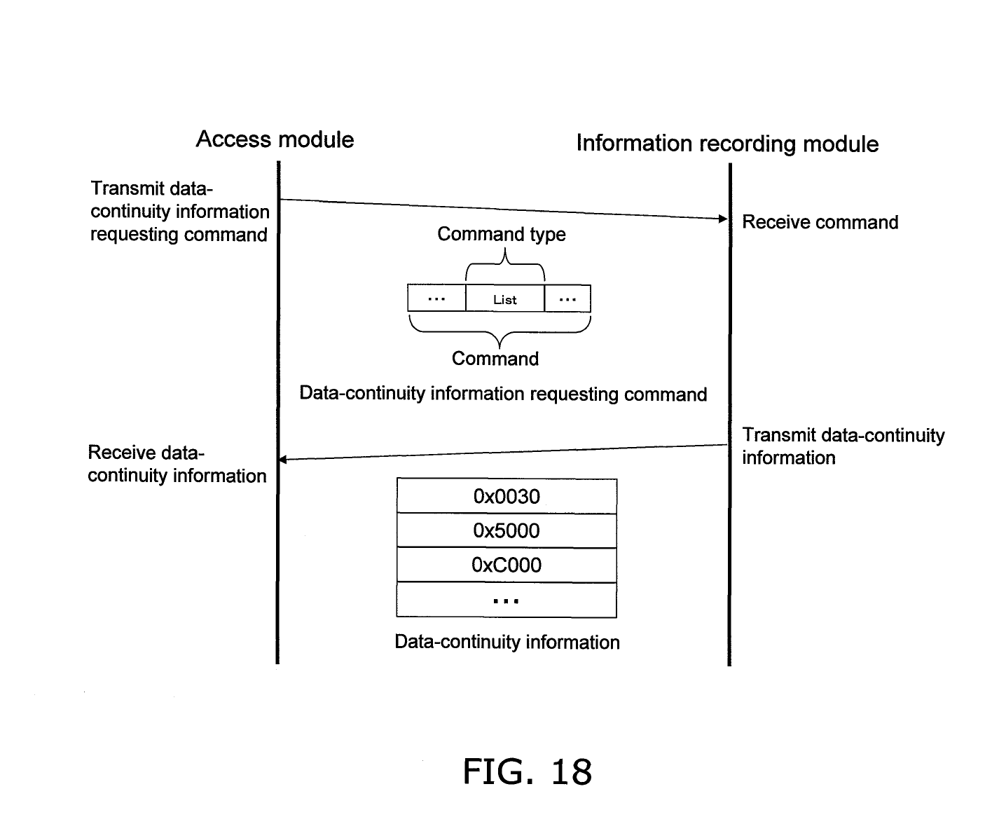

A sequence of processing for data reading performed in the information recording system will now be described with reference to FIG. 18.

In FIG. 18, the access module 110 first transmits a command requesting data-continuity information to the information recording module 100.

In response to the data-continuity information requesting command, the information recording module 100 changes the format of the data-continuity information having the structure of FIG. 8 or FIG. 14, which is managed by the data-continuity management unit 103, to a predetermined format, and transmits the data-continuity information having the predetermined format to the access module 110.

The access module 110 receives the data-continuity information.

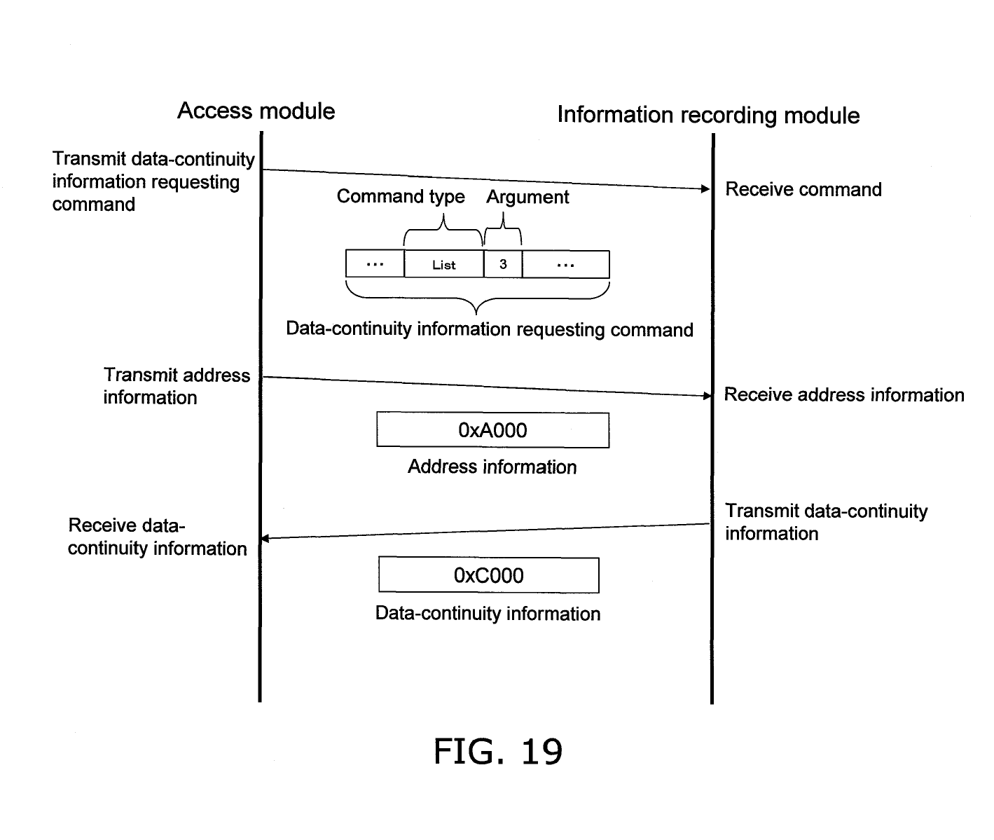

FIG. 19 shows a sequence of processing associated with a data-continuity information requesting command having another structure. In this example, an argument is set in the data-continuity information requesting command having the structure shown in FIG. 18. When, for example, the argument set in the command indicates 1, the information recording module 100 returns the entire data-continuity information, which may consist of a plurality of pieces of information, in the manner shown in FIG. 18. When the argument set in the command indicates 2, the information recording module 100 returns a single piece of data-continuity information in response to every data-continuity information requesting command to sequentially return a plurality of pieces of data-continuity information in the order of smaller addresses. When the argument set in the command indicates 3, the information recording module 100 further receives information about a designated address, and returns a piece of data-continuity information indicating an address greater than and closest to the designated address.

This structure of the information recording system of the present embodiment enables data-continuity information managed by the information recording module 100 to be returned in a variety of manners in accordance with an argument set in a data-continuity information requesting command.

The processing shown in FIG. 19 is performed between the access module and the information recording module when the argument is set to 3. The access module transmits, to the information recording module, a data-continuity information requesting command in which an argument is set to 3. The access module then transmits information about a designated address of 0xA000 to the information recording module. The information recording module receives a list of pieces of data-continuity information from the access module and obtains, from pieces of data-continuity information indicating address values greater than the designated address, a piece of data-continuity information corresponding to the smallest address, and returns the obtained piece of data-continuity information to the access module. When, for example, the information recording module stores the data-continuity information having the structure shown in FIG. 18, the information recording module transmits the data-continuity information 0xC000 to the access module.

The information recording system of the present embodiment described above uses a command with which the information recording module transmits a list of pieces of data-continuity information to the access module 110 to enable more specific data-continuity information to be obtained. This structure of the information recording system significantly reduces the overhead of the processing performed by the access module when, for example, seeks to file data are performed under the FAT file system.

Although the present embodiment describes the structure of the information recording system, the present invention should not be limited to the embodiment described above. The above embodiment may be modified without departing from the scope and spirit of the present invention. For example, the following modifications are possible.

(1) Although the present embodiment describes the case in which the access module 110 included in the information recording system transmits a command requesting data-continuity information to the information recording module 100 and the information recording module 100 returns a list of pieces of data-continuity information to the access module 110, the present invention should not be limited to this structure. In the information recording system, for example, the information recording module 100 may return a list of pieces of data-continuity information always arranged in the order of smaller addresses to the access module 110. Although the present embodiment describes the case in which an argument set in a data-continuity information requesting command indicates whether to obtain all pieces of data-continuity information included in the list, only selective pieces of data-continuity information included in the list, or only a piece of data-continuity information close to a designated address among a plurality of pieces of data-continuity information included in the list, the present invention should not be limited to this structure. The data-continuity information requesting command may have any other structure but is only required to enable data-continuity information managed by the information recording module to be obtained. For example, the information recording module may have a command returning information indicating whether data stored between a first logical address and a last logical address is continuous data. When receiving a command designating a first logical address and a last logical address transmitted from the access module 110, the information recording module may return a command including only information indicating whether the corresponding data is continuous data.

(2) Although the present embodiment describes the case in which the access module 110 included in the information recording system obtains a list of pieces of data-continuity information from the information recording module 100 when reading data, the present invention should not be limited to this structure. In the information recording system, for example, the information recording module 100 may have a mechanism for sending a message indicating that the data-continuity information list has been updated to the access module 110. The access module 110 may then transmit a command for newly obtaining the data-continuity information list to the information recording module 100 when receiving the message.

### Third Embodiment

A third embodiment of the present invention will now be described.

An information recording system according to the third embodiment differs from the information recording systems of the first and second embodiments in that the information recording system generates and transmits a command with which the information recording module 100 updates data-continuity information that is stored and managed in the information recording module 100. The information recording module 100 updates its internal data in response to the command transmitted from the access module 110. The other structure of the information recording system of the third embodiment is identical to the structures of the information recording systems of the above embodiments. The components of the information recording system of the present embodiment that are identical to the components in the above embodiments are given the same reference numerals as those components, and will not be described in detail.

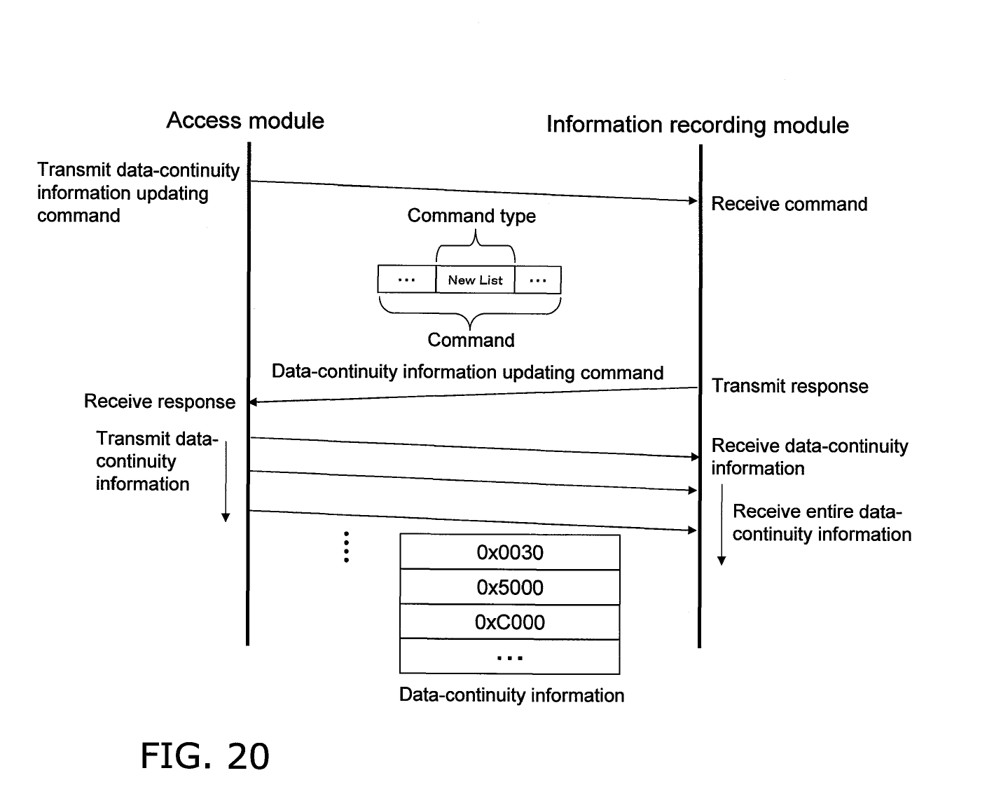

FIG. 20 shows a sequence of processing associated with a data-continuity information updating command in the information recording system of the present embodiment.

In the processing sequence shown in FIG. 20, the access module 110 first transmits a command for updating data-continuity information.

The information recording module 100 then returns a normal response to the access module 100 when determining that the data-continuity information can be updated.

The access module 110 receives the response from the information recording module. When the value of the response is normal, the access module 110 transmits the entire data-continuity information to the information recording module 100. The information recording module 100 receives the data-continuity information from the access module 110, and updates management information (data-continuity information) that is managed by the data-continuity management unit 103.

Although not shown, an argument may be set in the data-continuity information updating command in the same manner as in the command shown in FIG. 19 to designate specific pieces of data-continuity information to be updated by the information recording module of the information recording system. This enables only part (or pieces) of the data-continuity information managed in the information recording module 100 to be updated as described in the first and second embodiments.

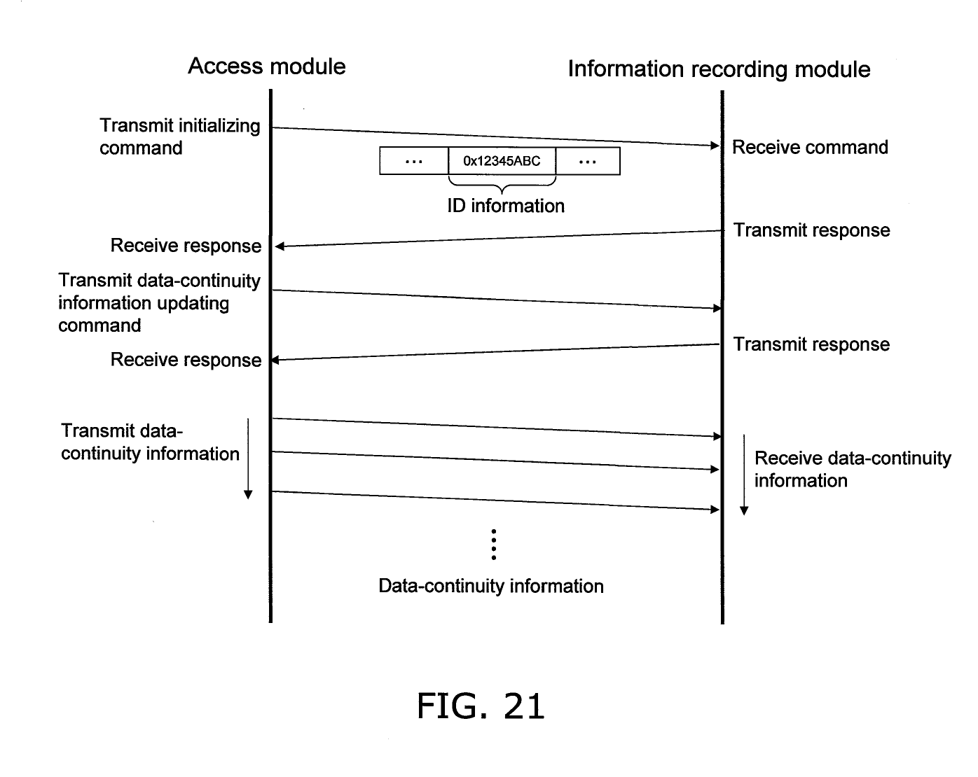

In the information recording system of the present embodiment, the data-continuity information transmitted in response to the data-continuity information updating command may be managed using ID information. FIG. 21 is a flowchart showing processing associated with a data-continuity information updating command when data-continuity information is managed using ID information.

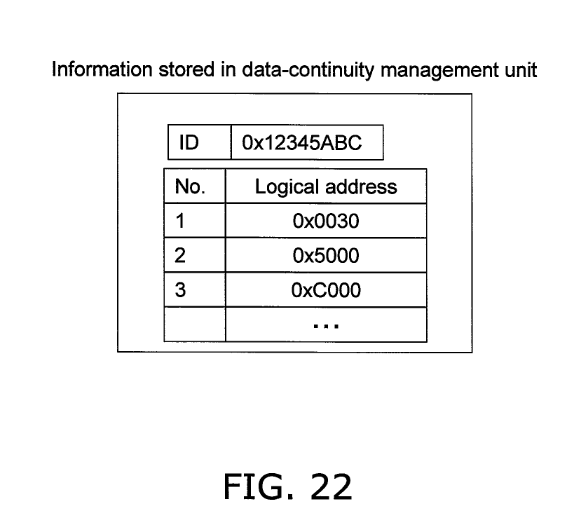

The access module 110 transmits ID information indicating a specific ID to the information recording module 100 when the information recording module 100 is initialized. In the example shown in FIG. 21, the access module 110 transmits a value of 0x12345ABC as the ID information. The information recording module 100 receives the ID information. When determining that the ID information transmitted from the access module 110 disagrees with ID information stored in the information recording module 100 having, for example, the structure shown in FIG. 22, the information recording module 100 erases the entire data-continuity address information. When the ID information transmitted from the access module 110 agrees with its internal ID information, the information recording module 100 uses the data-continuity address information without being required to update the data-continuity address information.

The information recording system manages the data-continuity information using ID information as described above, and this structure enables a plurality of different access modules to maintain compatibility in their data-continuity information. As described for the information recording systems of the first and second embodiments, the data-continuity address information stored in the information recording module may be transmitted to the access module. Also, the data-continuity address information stored in the information recording module may be updated as necessary in response to a command for updating data-continuity information as shown in FIG. 21.

As described above, the information recording system uses a command with which the access module 110 can update the data-continuity information managed by the information recording module 100. This structure of the information recording system enables the data-continuity information managed by the information recording module 100 to be updated.

Although the present embodiment describes the structure of the information recording system, the present invention should not be limited to the embodiment described above. The above embodiment may be modified without departing from the scope and spirit of the present invention. For example, the following modification is possible.

(1) Although the present embodiment describes the case in which the access module 110 included in the information recording system transmits a command for updating data-continuity information to the information recording module 100 and the information recording module 100 updates its internal list of pieces of data-continuity information, the present invention should not be limited to this structure. The data-continuity information updating command used in the information recording system may be any command with which the data-continuity address information managed by the information recording module 100 can be updated. For example, the access module 110 included in the information recording system may transmit information indicating a specific address to the information recording module, and the information recording module may update only a piece of data-continuity information associated with the transmitted address information in a manner to indicate that the corresponding data is not continuous (or may delete the piece of data-continuity information managed in the data-continuity management unit).

### Fourth Embodiment

A fourth embodiment of the present invention will now be described.

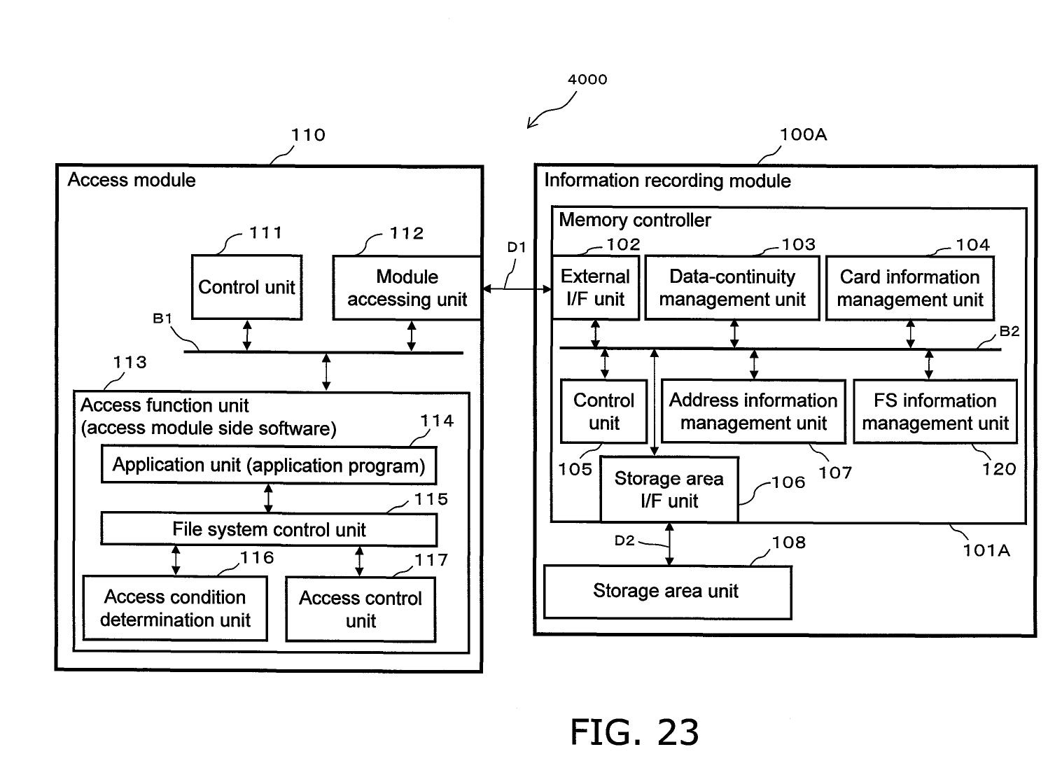

FIG. 23 is a block diagram showing the structure of an information recording system 4000 of the present embodiment.

The information recording system 4000 of the present embodiment differs from the information recording system 1000 of the first embodiment only in that the information recording system 4000 additionally includes an FS information management unit (file system information management unit) 120.

As shown in FIG. 23, the information recording system 4000 includes an access module 110 and an information recording module 100A.

The information recording module 100A includes a memory controller 101A and a storage area unit 108.

As shown in FIG. 23, the memory controller 101A further includes the FS information management unit (file system information management unit) 120 in addition to the structure of the memory controller 101 of the first embodiment.

The components of the information recording system of the present embodiment that are identical to the components in the above embodiment are given the same reference numerals as those components, and will not be described in detail.

The FS information management unit 120 compares data stored in the storage area unit 108 with file system management information and checks agreement between the data stored in the storage area unit 108 and the file system management information. When, for example, the information recording system 4000 uses the FAT file system, the FS information management unit 120 refers to information stored in the FAT or specifically the file system management information, and determines whether the information stored in the FAT agrees with information managed by the data-continuity management unit 103. More specifically, the FS information management unit 120 determines whether the data-continuity information managed by the data-continuity management unit 103 agrees with cluster chains managed using the FAT. When the data-continuity information managed by the data-continuity management unit 103 fails to agree with the cluster chains managed using the FAT, the FS information management unit 120 updates the information managed by the data-continuity management unit 103 based on the information stored in the FAT.

Sequence of Processing for Data Writing Performed when Data is Updated

A sequence of processing for data writing performed in the information recording system 4000 when data managed by the data-continuity management unit is updated, or specifically edited or deleted (or updated data is written newly), will now be described.

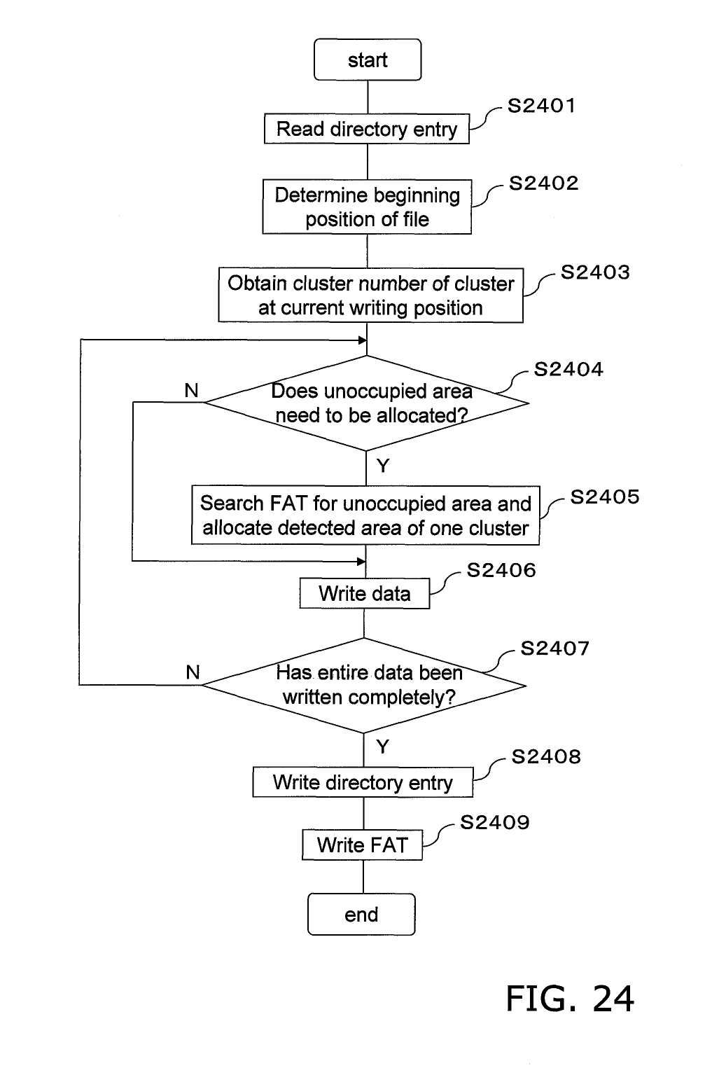

An example of processing for writing file data under the FAT file system will first be described with reference to FIGS. 24 to 26.

FIG. 24 is a flowchart showing a writing process performed by the access module 110.

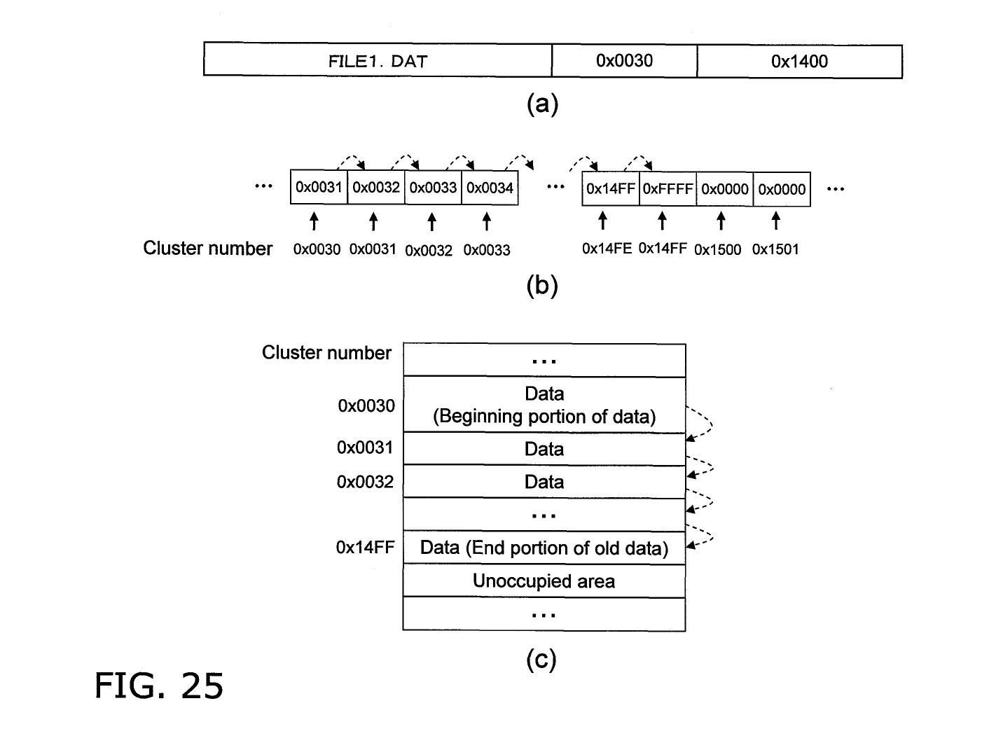

FIGS. 25A, 25B, and 25C show structures of the directory entry, the FAT, and the data area before the writing process is performed.

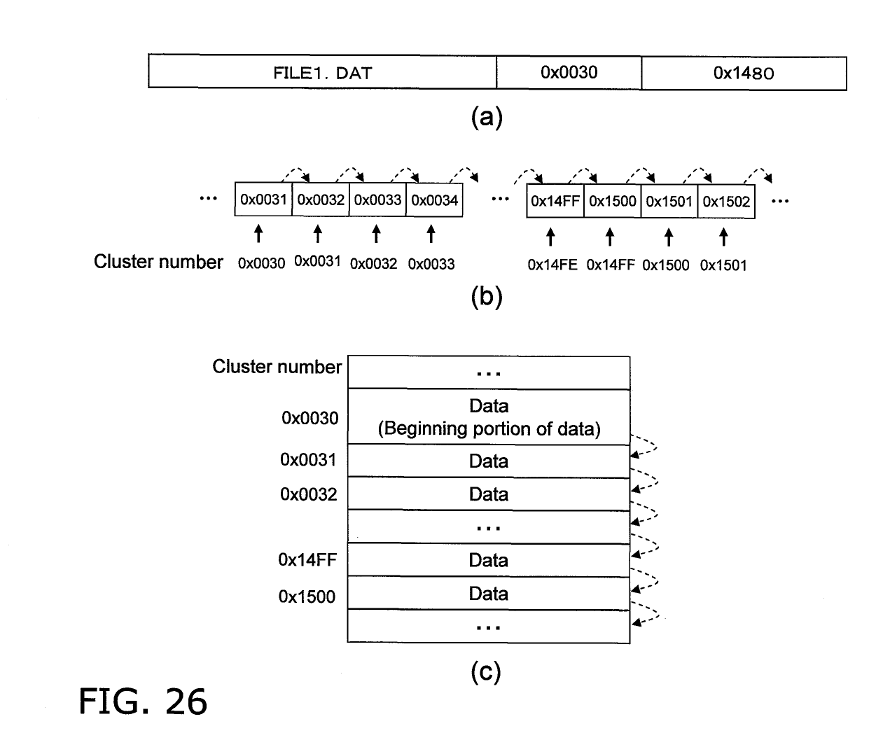

FIGS. 26A, 26B, and 26C show examples of the directory entry, the FAT, and the data areas after the writing process is performed. Under the FAT file system, the directory entry, which stores information such as a file name, a file size, and a file attribute, is a part of the root directory entry or a part of the data area.

FIG. 25A shows one example of the directory entry. A file corresponding to this directory entry has a file name of FILE1.DAT. The file data is stored using a plurality of clusters, of which the beginning portion of the file data is stored in the first cluster having a cluster number of 0x0030. This file has a file size of 0x1400 KB.

FIG. 25B shows an example of FAT data stored in the corresponding clusters having cluster numbers of 0x0030 to 0x14FF (including unoccupied clusters).

FIG. 25C shows data of the file having the file name of FILE1.DAT that is stored in 320 clusters among clusters having cluster numbers of 0x0030 to 0x14FF. In this example, a single cluster has a size of 16 KB.

### Processing for Writing File Data Under FAT File System

FIG. 24 shows an example of processing for writing file data under the FAT file system, which is performed by the file system control unit 115 included in the access module 110. The processing for writing file data performed by the file system control unit 115 in the access module 110 when the information recording system 4000 manages data under the FAT file system will now be described with reference to FIG. 24.

### Step S2401:

In the file data writing process, the file system control unit 115 first reads a directory entry of a target file.

### Step S2402:

The file system control unit 115 determines the beginning position of the file data by obtaining the first cluster number stored in the read directory entry, which is the cluster number of the first one of clusters into which file data has been stored.

### Step S2403:

The file system control unit 115 then reads the FAT, and follows links using the FAT sequentially from the beginning position of the file data obtained in step S2402, and obtains the cluster number of the cluster into which data is currently to be written.

### Step S2404:

Before writing the file data, the file system control unit 115 determines whether an unoccupied area needs to be newly allocated to the file. When determining that no unoccupied area needs to be allocated, the file system control unit 115 performs the processing in step S2406.

### Step S2405:

When determining that an unoccupied area needs to be allocated, the file system control unit 115 searches the FAT for an unoccupied area, and allocates an unoccupied area of one cluster to the end position of the file.

### Step S2406:

The file system control unit 115 writes the data into the cluster that is currently being referred to. More specifically, the file system control unit 115 writes the data into the current cluster by transmitting a command for writing the data into the current cluster to the information recording module 100A.

### Step S2407:

The file system control unit 115 determines whether the entire data has been written completely. When determining that the entire data has yet to be written, the file system control unit 115 returns to the processing in step S2404.

### Step S2408:

When determining that the entire data has been written completely, the file system control unit 115 updates the file size, the time stamp, and other necessary information stored in the directory entry, and writes the updated information into the information recording module 100A. More specifically, the file system control unit 115 transmits, to the information recording module 100A, a command for writing the updated information into the information recording module 100.

### Step S2409:

The file system control unit 115 transmits, to the information recording module 100A, a command for writing the FAT into the information recording module 100A. The information recording module 100A writes the FAT into the recording area unit 108 in response to the received command. The file system control unit 115 then ends the processing.

The information recording system 4000 may perform the file data writing process described above to write data of 128 KB into the file having the file name of FILE1.DAT, which stores data having the size of 0x1400 KB shown in FIG. 25. In this case, as shown in FIGS. 26A, 26B, and 26C, new data is written into the cluster with the cluster number of 0x1500 and subsequent clusters. This data writing process changes (or updates) the file having the file name of FILE1.DAT to a file having a data size of 0x1480 KB.

Under the FAT file system, storage areas into which file data is stored are allocated in units of clusters as described above, and the data is stored into the allocated storage areas.

Although the present embodiment describes the processing performed when recorded data is updated, the size of the recorded data may be unchanged and only the arrangement or more specifically the logical addresses of the data and its management data such as the FAT in the file system may be changed when editing operations including deletion, splitting, and integrating of data are performed or when a procedure called defragmentation, which aims to prevent fragmentation in the FAT file system, is performed.

Sequence of Internal Processing Performed by Information Recording Module 100 when Data is Updated

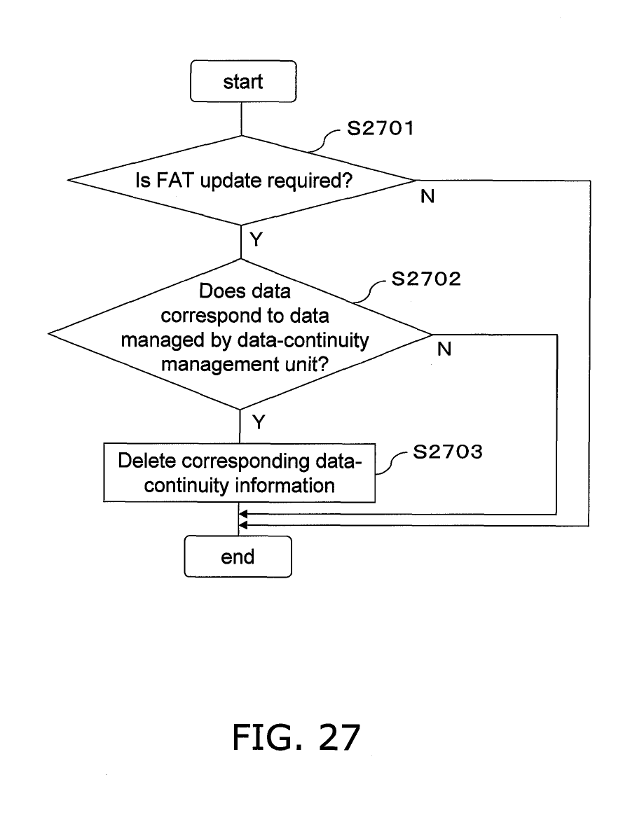

A sequence of internal processing performed by the information recording module 100 when data is updated, such as when recorded data is updated in the manner described above, between the information recording module 100A and the access module 110 in the information recording system 4000 will now be described with reference to FIG. 27.

A sequence of processing performed by the access module 110 when data is written into the information recording module 100A is basically identical to the sequence of processing shown in FIG. 6. The processing shown in FIG. 27 is performed before step S701 included in the determination process shown in FIG. 7, which shows in detail the processing in step S606 included in the data writing process shown in FIG. 6.

### Step S2701:

The FS information management unit 120 determines whether a data writing command transmitted from the access module 110 requires processing for updating the FAT based on a logical address of a data writing position indicated by the data writing command. When the command does not require the processing for updating the FAT, the FS information management unit 120 ends the processing.

### Step S2702:

When determining that the command requires the processing for updating the FAT in step S2701, the FS information management unit 120 further determines whether data stored in the FAT to be updated corresponds to data managed by the data-continuity management unit 103. When the data stored in the FAT does not correspond to the data managed by the data-continuity management unit 103, the FS information management unit 120 ends the processing.

### Step S2703:

When determining that the data stored in the FAT corresponds to the data managed by the data-continuity management unit 103 in step S2702, the FS information management unit 120 deletes the corresponding pieces of data-continuity information, and then may perform processing for shifting the storage positions of subsequent pieces of data-continuity information as necessary.

As described above, the FS information management unit 120 included in the information recording module 100A checks agreement between the data-continuity information managed by the data-continuity management unit 103 and the information stored in the FAT, and updates the data-continuity information as necessary. This structure of the information recording system 4000 enables the data-continuity information managed by the data-continuity management unit 103 to constantly agree with the information used in the file system.

Although the present embodiment describes the structure of the information recording system 4000, the present invention should not be limited to the embodiment described above. The above embodiment may be modified without departing from the scope and spirit of the present invention.

### Fifth Embodiment

A fifth embodiment of the present invention will now be described.

An information recording system according to the fifth embodiment differs from the information recording system of the fourth embodiment in that the information recording system generates and transmits a command with which the information recording module 100A generates data-continuity information for data that is managed by a data-continuity management unit 103 included in the information recording system, and an FS information management unit 120 checks the FAT information and the data storage state in response to the data-continuity information generation command transmitted from an access module 110 and generates data-continuity information. The other structure of the information recording system of the fifth embodiment is basically identical to the structure of the information recording system of the fourth embodiment. The components of the information recording system of the present embodiment that are identical to the components in the above embodiment are given the same reference numerals as those components, and will not be described in detail.

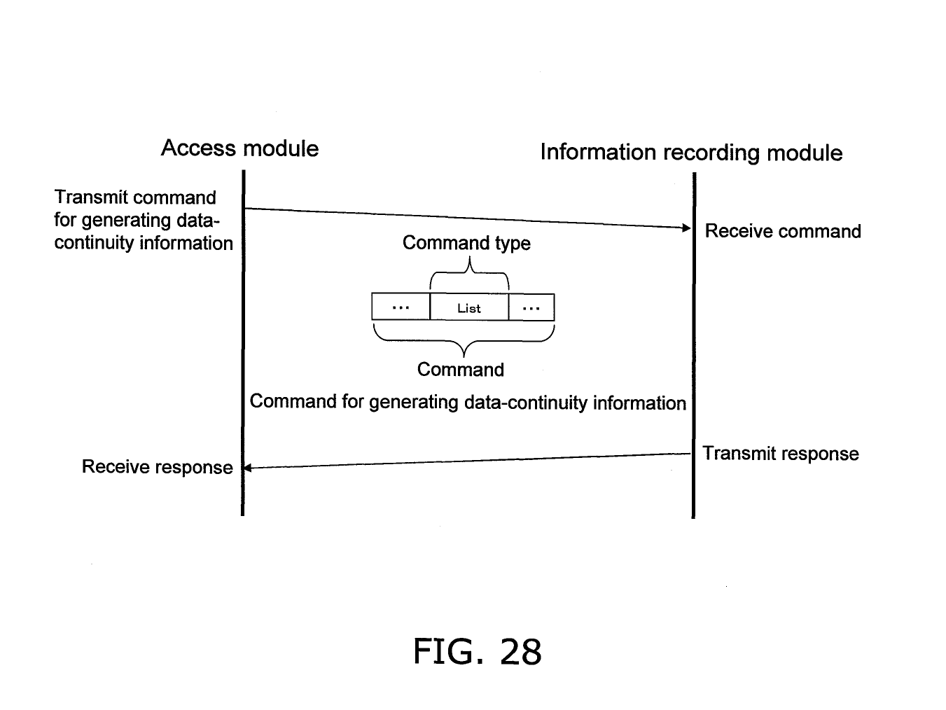

FIG. 28 shows a sequence of processing for transmitting a command for generating data-continuity information performed in the information recording system of the present embodiment.

As shown in FIG. 28, the access module 110 transmits a command for newly generating data-continuity information that is managed by the data-continuity management unit 103. The information recording module 100 receives the data-continuity information generating command, and abandons the existing data-continuity information managed by the data-continuity management unit 103, and newly determines whether data with a predetermined area length is stored at continuous logical addresses by referring to the FAT. When determining that the data having a predetermined area length is stored at continuous logical addresses, the information recording module 100 generates data-continuity information having, for example, the structure shown in FIG. 8, and manages the generated data-continuity information in the data-continuity management unit 103.

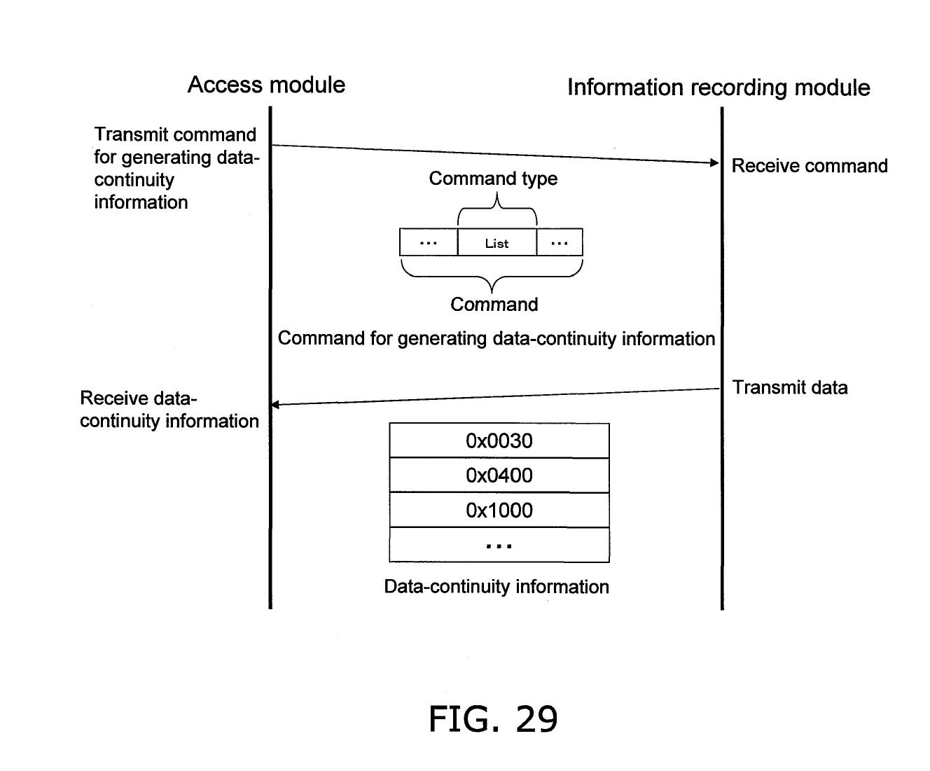

Although FIG. 28 shows the processing performed in the information recording system of the present embodiment in which the information recording module 100A returns a response to the access module 110 immediately after receiving the command, the processing may be modified to the processing shown in FIG. 29. In FIG. 29, the information recording module 100A receives the command, and generates data-continuity information and returns the generated data-continuity information to the access module 110 instead of returning a response to the access module 110.

The information recording system of the present embodiment described above generates and transmits a command with which the information recording module 100A generates data-continuity information for data. By using such a command, the access module 110 can request processing to be performed by the information recording module 100A when the access module 110 has yet to read data from the information recording module 100A or when data-continuity information needs to be newly generated.

In the information recording system of the present embodiment, the information recording module 100A can transmit the generated data-continuity information to the access module 110. This structure of the information recording system significantly reduces the overhead of the processing performed by the access module 110 when, for example, seeks to file data are performed under the FAT file system.

Although the present embodiment describes the structure of the information recording system, the present invention should not be limited to the embodiment described above. The above embodiment may be modified without departing from the scope and spirit of the present invention. For example, the following modifications are possible.

(1) Although the present embodiment describes the case in which the information recording module 100 included in the information recording system abandons the existing data-continuity information stored in the data-continuity management unit 103 and newly generates data-continuity information when receiving a command for generating data-continuity information transmitted from the access module 110, the present invention should not be limited to this structure. For example, the information recording module 100 included in the information recording system may not abandon the existing data-continuity information stored in the data-continuity management unit 103 but may check agreement between the existing data-continuity information and the information stored in the FAT. When finding any new piece of data-continuity information stored in the FAT, the information recording module 100 may add the new piece of data-continuity information into the data-continuity information table. When finding any old piece of data-continuity information already deleted from the FAT, the information recording module 100 may delete the old piece of data-continuity information from the data-continuity information table. Further, an argument may be set in the data-continuity information generation command to indicate whether the existing data-continuity information managed by the data-continuity management unit 103 is to be updated or new data-continuity information is to be generated. Alternatively, the information recording system may use a command for only deleting the entire data-continuity information stored in the data-continuity management unit 103 without requiring data-continuity information to be generated newly.

(2) Although the present embodiment describes the case in which the access module 110 included in the information recording system transmits a data-continuity information generation command to the information recording module 100A and the information recording module 100A newly generates data-continuity information in response to the command, the present invention should not be limited to this structure. More specifically, the information recording system may generate data-continuity information without using a command for generating data-continuity information. For example, the information recording module included in the information recording system may automatically generate data-continuity information at predetermined timings, such as when data having a predetermined area length is written, the FAT data is updated, a predetermined time has elapsed, or the information recording system is initially powered on.

### Other Embodiments

The above embodiments (first to fifth embodiments) may be commonly modified in the following manners.

(1) Although the above embodiments describe the case in which the information recording system uses the FAT file system, the information recording system may process data using any other file system or any other method that enables the information recording module 100 (or 100A) to recognize or manage logical addresses of data stored and also enables the access module 110 to obtain data-continuity information for the data.

(2) Although the above embodiments describe the case in which the information recording module is formed using a semiconductor device, the present invention should not be limited to this structure. For example, the information recording module may be formed using an element that can record digital data, such as a magnetic medium.

(3) Although the above embodiments describe the case in which the information recording module is formed using a semiconductor memory card, the present invention should not be limited to this specific structure of the information recording module. For example, the information recording module may be any recording medium that is removable, or may be an electronic device formed by integrating the information recording module and the access module, such as a player, a recorder, a mobile telephone, or a personal computer.

(4) Although the above embodiments describe the case in which the continuity of data is defined in the logical address space, the continuity of data may be defined in a physical address space when logical addresses and physical addresses are identical.

The controller, the information recording module, the access module, the information recording system etc. described in the above embodiments may be implemented as methods. To implement these modules and system using methods, the components described above are only required to be replaced by steps that are executed by, for example, a CPU.

The modules described in the above embodiments of the present invention may not necessarily be devices, but may be units or devices that have the functions equivalent to the functions of the modules described in the above embodiments.

Each block of the information recording system, the access module, and the information recording module described in the above embodiments may be formed using a single chip with a semiconductor device, such as LSI (large-scale integration), or some or all of the blocks of the information recording system, the access module, and the information recording module may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks. Biotechnology is potentially applicable.

The processes described in the above embodiments may be achieved using either hardware or software, or may be achieved using both software and hardware. When the information recording system, the access module, and the information recording module of the above embodiments are implemented by hardware, the information recording system, the access module, and the information recording module require timing adjustment for each of their processes. For ease of explanation, timing adjustment associated with various signals required in an actual hardware design is not described in detail in the above embodiments.

The specific structures described in the above embodiments are mere examples of the present invention, and may be changed and modified variously without departing from the scope and spirit of the invention.

### INDUSTRIAL APPLICABILITY

The controller, the access module, the information recording system, and the information recording method of the present invention enable a recording medium to function to write or read information about right at a high speed, and are implementable as a method for recording data into a recording medium. The controller, the access module, the information recording system, and the information recording method of the present invention are thus useful and implementable in the field of data recording and reading technology.

1. A controller for controlling data writing or data reading to or from an information recording medium, the controller comprising:
a control unit that detects a continuity of data in an address space of a file system, the file system managing data that is recorded into the information recording medium; and
a data-continuity management unit that stores information about the continuity of data as data-continuity information.

2. The controller according to claim 1, wherein
the control unit outputs information based on the data-continuity information that is stored in the data-continuity management unit to an external unit.

3. The controller according to claim 1, wherein
the control unit changes the data-continuity information stored in the data-continuity management unit in accordance with a request transmitted from an external unit.

4. The controller according to claim 1, further comprising:
a file system information management unit that recognizes information managed by the file system.

5. The controller according to claim 4, wherein
the file system information management unit changes the data-continuity information based on the data-continuity information and the information managed by the file system.

6. The controller according to claim 4, wherein
the file system information management unit changes the data-continuity information based on the data-continuity information and the information managed by the file system when a request to change the data-continuity information is transmitted from an external unit.

7. The controller according to claim 1, wherein
the information recording medium to be controlled is a nonvolatile memory.

8. An information recording device including an information recording medium and a controller for controlling data writing or data reading to or from the information recording medium, wherein
the controller includes a control unit that detects a continuity of data in an address space of a file system managing data recorded into the information recording medium and a data-continuity management unit that stores information about the continuity of data as data-continuity information.

9. The information recording device according to claim 8, wherein
the controller further includes a card information management unit that stores an access condition under which data is recorded continuously into the information recording medium, and
the control unit outputs the access condition to an external unit.

10. The information recording device according to claim 8, wherein
the control unit outputs information based on data-continuity information that is stored in the data-continuity management unit to an external unit.

11. The information recording device according to claim 8, wherein
the control unit changes data-continuity information stored in the data-continuity management unit in accordance with a request transmitted from an external unit.

12. An information recording device including an information recording medium and a controller for controlling data writing or data reading to or from the information recording medium, wherein
the controller includes a control unit that detects a continuity of data in an address space of a file system managing data that is recorded into the information recording medium, a data-continuity management unit that stores information about the continuity of data as data-continuity information, and a file system information management unit that recognizes information managed by the file system.

13. The information recording device according to claim 12, wherein
the file system information management unit changes the data-continuity information based on the data-continuity information and the information managed by the file system.

14. The information recording device according to claim 12, wherein
the file system information management unit changes the data-continuity information based on the data-continuity information and the information managed by the file system when a request to change the data-continuity information is transmitted from an external unit.

15. The information recording device according to claim 5, wherein
the information recording medium is a nonvolatile memory.

16. An access device that connects an information recording medium and an information recording device, the information recording device including a controller for controlling the information recording medium, the access device comprising:
a control unit that receives from the information recording device an access condition under which data is recorded continuously into the information recording medium; and
a file system control unit that determines an address of data that is recorded into the information recording medium based on the access condition.

17. An access device that connects an information recording medium and an information recording device, the information recording device including a controller for controlling the information recording medium, the access device comprising:
a control unit that receives from the information recording device data-continuity information indicating a continuity of data in an address space that has been recorded into the information recording medium; and
a file system control unit that receives data from the information recording device based on the data-continuity information.

18. An information recording system comprising:
the information recording device according to claim 8; and
an access device that connects the information recording medium and the information recording device,
wherein the information recording device includes a controller for controlling the information recording medium, and
the access device comprises:
a control unit that receives from the information recording device an access condition under which data is recorded continuously into the information recording medium; and
a file system control unit that determines an address of data that is recorded into the information recording medium based on the access condition.

19. An information recording method for controlling data writing to an information recording medium, the method comprising:
managing a recording position at which data is recorded into the information recording medium using an address;
detecting a continuity of data in the address space; and
storing information about the continuity of data as data-continuity information.

20. The information recording method according to claim 19, further comprising:
recognizing information managed by the file system.
